(19) United States
(12) Patent Application Publication
(10) Pub. No.: US 2025/0108534 A1
(43) Pub. Date: Apr. 3, 2025

(54) CUTTING DEVICE AND CUTTING SYSTEM

(71) Applicant: BROTHER KOGYO KABUSHIKI KAISHA, Nagoya (JP)

(72) Inventors: Yukitoshi WATANABE, Nagoya (JP); Shinya FUJIHARA, Obu (JP)

(21) Appl. No.: 18/788,776

(22) Filed: Jul. 30, 2024

(30) Foreign Application Priority Data
Sep. 29, 2023 (JP) 2023-170032

(51) Int. Cl. B26F 1/38; B26D 5/00; B26D 7/01; B26D 7/26

(52) U.S. Cl. CPC B26F 1/382; B26D 5/00; B26D 7/015; B26D 7/2614

(57) ABSTRACT

A cutting device includes a platen with a groove, a blade mount, a first conveyor, a second conveyor, a third conveyor, a memory, and a processor. The processor is configured to perform processes including acquiring outline data indicating an outline of a pattern, controlling the first conveyor and the second conveyor to form a first cutting line by the cutting blade mounted to the blade mount positioned at a first cutting position. The first cutting line is a groove-shaped cut along the outline. The processes further include controlling the first conveyor and the second conveyor to form a second cutting line by the cutting blade mounted to the blade mount positioned at a second cutting position. The second cutting line is a cut completely passing through the cutting object in the up-down direction along a portion of the outline.

### REFERENCE TO RELATED APPLICATIONS

This application claims priority from Japanese Patent Application No. 2023-170032 filed on Sep. 29, 2023. The entire content of the priority application is incorporated herein by reference.

### BACKGROUND ART

The present disclosure relates to a cutting device and a cutting system.

When forming a cutting line in a pre-created sheet-shaped medium, a known cutting device pulls the sheet-shaped medium in a conveyance direction by driving a drive roller while sandwiching the sheet-shaped medium between a cutter member configured to move up and down and a cutter groove formed in an upper surface of a placement platform. The cutting device forms the cutting line with a cutter blade on the pulled sheet-shaped medium along a direction orthogonal to the conveyance direction.

### SUMMARY

With the known cutting device, when the sheet-shaped medium is pulled by the drive roller, the sheet-shaped medium is pulled in the conveyance direction while the cutter blade is lowered and in contact with the sheet-shaped medium, such that an unintended cutting line is formed in the conveyance direction.

Embodiments of the broad principles derived herein provide a cutting device and a cutting system that, compared to known art, contributes to an increase in cutting accuracy when cutting a cutting object without using an object holder.

Embodiments provide a cutting device that includes a platen with a groove extending in a main scanning direction, a blade mount configured to mount a cutting blade, a first conveyor, a second conveyor, a third conveyor, and a processor. The first conveyor is configured to move the blade mount and a cutting object placed on the platen relatively in the main scanning direction, the cutting object having a sheet shape. The second conveyor is configured to move the blade mount and the cutting object placed on the platen relatively in a sub-scanning direction orthogonal to the main scanning direction. The third conveyor is configured to move the blade mount in an up-down direction orthogonal to both the main scanning direction and the sub-scanning direction. The processor is configured to perform processes. The processes include acquiring outline data indicating an outline of a pattern, controlling the first conveyor and the second conveyor to move the cutting object and the blade mount relatively to a cut starting position, and controlling the third conveyor to move the blade mount downward to a first cutting position. The first cutting position is a position where a lower end of the cutting blade is below an upper end of the cutting object, and the lower end of the cutting blade is above an upper end of the platen. The processes include controlling the first conveyor and the second conveyor to form a first cutting line by the cutting blade mounted to the blade mount positioned at the first cutting position. The first cutting line is a groove-shaped cut along the outline. The processes include controlling, after forming the first cutting line, the third conveyor to move the blade mount downward to a second cutting position. The second cutting position is a position where the lower end of the cutting blade is below the upper end of the platen, and the lower end of the cutting blade is positioned in the groove. The processes include controlling the first conveyor and the second conveyor to form a second cutting line by the cutting blade mounted to the blade mount positioned at the second cutting position. The second cutting line is a cut completely passing through the cutting object in the up-down direction along a portion of the outline. When cutting the cutting object along the outline of the pattern, after forming the groove-shaped first cutting line, the cutting device forms the second cutting line along a portion of the outline of the pattern in order to form a joint, which is a portion where the cutting object is not cut completely through in the up-down direction. The processor of the cutting device contributes to a reduction in pressure applied to the cutting object when forming the second cutting line, compared to when the first cutting line is not formed. Therefore, the processor of the cutting device contributes to inhibiting the formation of an unintended cutting line in the cutting object due to flexure of the cutting object caused by pressure applied to the cutting object from the cutting blade during formation of the second cutting line, thereby contributing to an increase in cutting accuracy compared to known art when cutting a cutting object without using an object holder.

Embodiments further provide a cutting system that is provided with a cutting device, and a mobile terminal configured to communicate with the cutting device. The mobile terminal includes a terminal processor configured to perform processes. The processes include receiving an input of cutting information specifying a cutting method of a cutting object, the cutting object having a sheet shape, and transmitting the cutting information to the cutting device. The cutting device includes a platen with a groove extending in a main scanning direction, a blade mount configured to mount a cutting blade, a first conveyor, a second conveyor, a third conveyor and a cutting processor. The first conveyor is configured to move the blade mount and a cutting object placed on the platen relatively in the main scanning direction, the cutting object having a sheet shape, and a cutting processor. The second conveyor is configured to move the blade mount and the cutting object placed on the platen relatively in a sub-scanning direction orthogonal to the main scanning direction. The third conveyor is configured to move the blade mount in an up-down direction orthogonal to both the main scanning direction and the sub-scanning direction. The cutting processor is configured to perform processes. The processes include receiving the cutting information transmitted from the mobile terminal, acquiring outline data indicating an outline of a pattern, controlling the first conveyor and the second conveyor to move the cutting object and the blade mount relatively to a cut starting position. The processes include controlling the third conveyor to move the blade mount downward to a first cutting position. The first cutting position is a position where, when the cutting information indicates the cutting method for cutting the cutting object when the cutting object is placed directly on the platen, a lower end of the cutting blade is below an upper end of the cutting object, and the lower end of the cutting blade is above an upper end of the platen. The processes include controlling the first conveyor and the second conveyor to form a first cutting line by the cutting blade mounted to the blade mount positioned at the first cutting position. The first cutting line is a groove-shaped cut along the outline. The processes include controlling, after forming the first cutting line, the third conveyor to move the blade mount downward to a second cutting position. The second cutting position is a position where the lower end of the cutting blade is below the upper end of the platen, and the lower end of the cutting blade is positioned in the groove. The processes include controlling the first conveyor and the second conveyor to form a second cutting line by the cutting blade mounted to the blade mount positioned at the second cutting position. The second cutting line is a cut completely passing through the cutting object in the up-down direction along a portion of the outline. The cutting system contributes to forming the first cutting line and the second cutting line when the cutting information input to the mobile terminal and transmitted to the cutting device indicates the cutting method for cutting the cutting object with the cutting object placed directly on the platen. When cutting the cutting object along the outline of the pattern, after forming the groove-shaped first cutting line, the cutting device forms the second cutting line along a portion of the outline of the pattern in order to form a joint, which is a portion where the cutting object is not cut completely through in the up-down direction. The cutting device of the cutting system contributes to a reduction in pressure applied to the cutting object when forming the second cutting line, compared to when the first cutting line is not formed. Therefore, the processor of the cutting device contributes to inhibiting the formation of an unintended cutting line in the cutting object due to flexure of the cutting object caused by pressure applied to the cutting object from the cutting blade during formation of the second cutting line, thereby contributing to an increase in cutting accuracy compared to known art when cutting a cutting object without using an object holder.

Embodiments also provide a cutting device that includes a platen, a blade mount, a first conveyor, a second conveyor, a third conveyor, and a processor. The platen has an upper surface and a groove. The groove is a depression recessed downward from the upper surface. The groove extends in a main scanning direction. The blade mount is configured to mount a cutting blade. The cutting blade is disposed to face the groove. The first conveyor is configured to move the blade mount relative to the platen in the main scanning direction to move a lower end of the cutting blade along the groove. The second conveyor is configured to move a sheet placed on the platen relative to the platen in a sub-scanning direction intersecting the main scanning direction. The third conveyor is configured to move the blade mount relative to the sheet placed on the platen in an up-down direction intersecting both the main scanning direction and the sub-scanning direction. The processor is configured to perform processes. The processes include acquiring outline data indicating an outline of a pattern, controlling the first conveyor and the second conveyor to move the blade mount to a cut starting position, and controlling the third conveyor to move the blade mount downward from a first initial position to a first cutting position. The first initial position is a position where the lower end of the cutting blade is positioned above an upper surface of the sheet. The first cutting position is a position where the lower end of the cutting blade is positioned between the upper surface of the sheet and the upper surface of the platen. The processes include controlling the first conveyor and the second conveyor to form a first cutting line by the cutting blade mounted to the blade mount positioned at the first cutting position. The first cutting line is a groove-shaped cut along the outline. The processes include controlling, after forming the first cutting line, the third conveyor to move the blade mount downward from a second initial position to a second cutting position. The second initial position is a position where the lower end of the cutting blade is positioned above the upper surface of the sheet. The second cutting position is a position where the lower end of the cutting blade is positioned below the upper surface of the platen. The processes include controlling the first conveyor and the second conveyor to form a second cutting line by the cutting blade mounted to the blade mount positioned at the second cutting position. The second cutting line is a cut completely passing through the sheet in the up-down direction along a portion of the outline. When cutting the sheet along the outline of the pattern, after forming the groove-shaped first cutting line, the cutting device forms the second cutting line along a portion of the outline of the pattern in order to form a joint, which is a portion where the sheet is not cut completely through in the up-down direction. The processor of the cutting device contributes to a reduction in pressure applied to the sheet when forming the second cutting line, compared to when the first cutting line is not formed. Therefore, the processor of the cutting device contributes to inhibiting the formation of an unintended cutting line in the sheet due to flexure of the sheet caused by pressure applied to the sheet from the cutting blade during formation of the second cutting line, thereby contributing to an increase in cutting accuracy compared to known art when cutting a sheet without using an object holder.

### BRIEF DESCRIPTION OF DRAWINGS

FIG. 1A is a perspective view of a cutting device in a state in which an object holder that holds a cutting object is placed on a platen.

FIG. 1B is a perspective view of the cutting device in a state in which the cutting object is placed directly on the platen.

FIG. 2 is a perspective view of a carriage with a holder attached.

FIG. 3 is a front view of the carriage and the holder in a raised position.

FIG. 4 is a block diagram of a cutting system provided with the cutting device and a mobile terminal.

FIG. 5 is a flowchart of mobile terminal processing executed by the mobile terminal, and cutting device processing executed by the cutting device.

FIG. 6A is an explanatory diagram of patterns of first and second specific examples, and FIG. 6B to FIG. 6D are explanatory diagrams of cutting lines set for those patterns.

FIG. 7A is an explanatory diagram of patterns of third and fourth specific examples, and FIG. 7B to FIG. 7D are explanatory diagrams of cutting lines set for those patterns.

FIG. 8 is a flowchart of cutting processing executed in the cutting device processing of FIG. 5.

FIG. 9 is a flowchart of data conversion processing executed in the cutting processing of FIG. 8.

FIG. 10 is an explanatory diagram of processing for setting a first cutting position and a second cutting position when cutting, with a cutting blade, the cutting object placed directly on the platen.

FIG. 11 is an explanatory diagram of processing for setting a third cutting position, a fourth cutting position, and a fifth cutting position when cutting, with the cutting blade, the cutting object held by the object holder.

FIG. 12 is a flowchart of object holder processing executed in the cutting processing of FIG. 8.

### DESCRIPTION

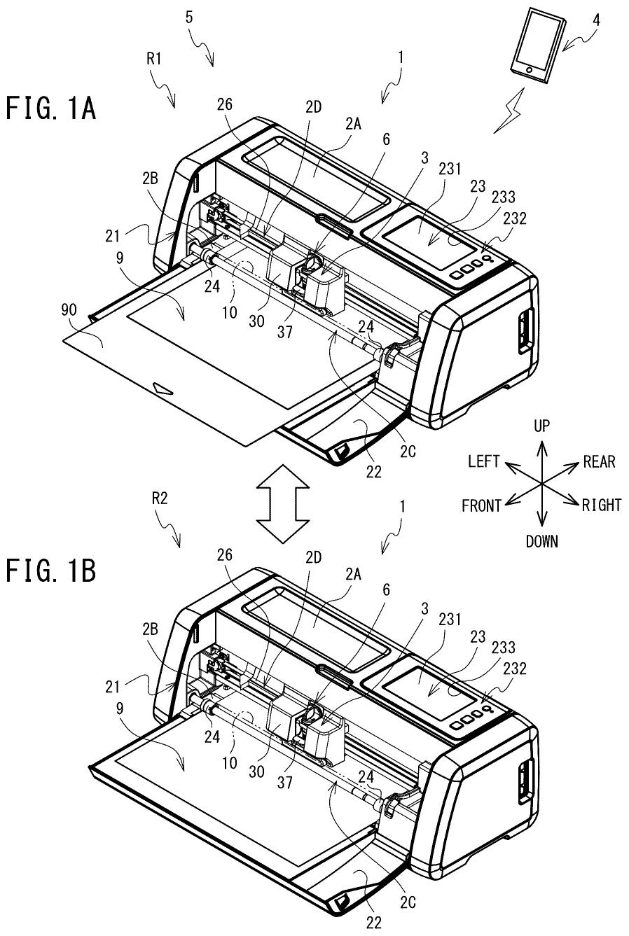

Embodiments embodying a cutting device 1 and a cutting system 5 according to the present disclosure will be described with reference to the drawings. The drawings to be referenced are used to illustrate the technical features that can be adopted in the present disclosure, and the described configurations and the like of the devices are not intended to be limited thereto, but are merely explanatory examples. The lower left side, the upper right side, the lower right side, the upper left side, the upper side, and the lower side in FIG. 1A and FIG. 1B are the front side, the rear side, the right side, the left side, the upper side, and the lower side, respectively, of the cutting device 1.

An overview of the cutting device 1 will be described with reference to FIG. 1A to FIG. 3. The cutting device 1 is configured to cut a cutting object 9 with a cutting blade 16 held by the holder 6. FIG. 1A illustrates the cutting device 1 in a state R1 in which the cutting object 9 is held by an object holder 90. FIG. 1B illustrates the cutting device 1 in a state R2 in which the cutting object 9 is not held by the object holder 90 but is placed directly on a platen 2B. The object holder 90 is a mat made of synthetic resin material, for example. The cutting object has a sheet shape. The cutting object 9 is a sheet of paper, cloth, or plastic, for example. In the state R1, the cutting object 9 is attached to an adhesive layer on an upper surface of the object holder 90 and held there. The cutting device 1 is provided with a main body cover 2A, a platen 2B, a carriage 3, a second conveyor 2C and a first conveyor 2D and the like.

An opening portion 21, a cover 22, and an operating portion 23 are provided on the main body cover 2A. The opening portion 21 is an opening formed in a front surface portion of the main body cover 2A. The cover 22 is rotatably supported on the main body cover 2A. In FIG. 1A, the cover 22 is open, and the opening portion 21 is in an open state. Hereinafter, various configurations are explained on the basis of the state in which the cover 22 is open. The operating portion 23 is located on a right side portion of an upper surface of the main body cover 2A, and provided with a liquid crystal display (LCD) 231, a plurality of operating switches 232, and a touch screen 233. An image including various items, such as commands, illustrations, setting values, and messages is displayed on the LCD 231. The touch screen 233 is provided on a surface of the LCD 231. A user performs a pressing operation on the touch screen 233, using either a finger or a stylus pen. In the cutting device 1, which of the items has been selected is recognized in accordance with a pressed position detected by the touch screen 233. The user can use the operating switches 232 and the touch screen 233 to select a pattern displayed on the LCD 231, set various parameters, perform an input operation, and the like.

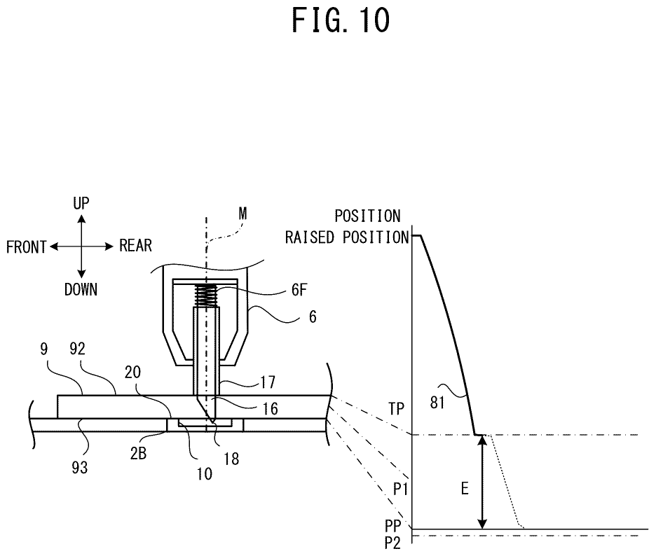

The platen 2B is provided inside the main body cover 2A. The platen 2B is a plate-shaped member that extends in the left-right direction. The length of the platen 2B in the left-right direction is greater than the width of the object holder 90 and the cutting object 9 in the left-right direction. In the state R1, the object holder 90 is placed on a portion of an upper surface of the platen 2B excluding portions at both ends in the left-right direction. In other words, the cutting object 9 held by the object holder 90 is placed on the platen 2B via the object holder 90. When in the state R2, the cutting object 9 is placed on a portion of an upper surface of the platen 2B, excluding portions at both ends in the left-right direction. A groove 10 extending in the main scanning direction is formed in the platen 2B. The main scanning direction of the present embodiment is the left-right direction. As shown in FIG. 10, the groove 10 is a recess that is positioned below the cutting blade 16 held by the holder 6, and configured to accommodate a blade lower end 18 that is a lower end of the cutting blade 16 that has been lowered to a second cutting position P2, described later, and is a depression recessed below a platen upper surface 20 that is the upper end of the platen 2B, i.e., below an object lower end 93 that is the lower end of the cutting object 9.

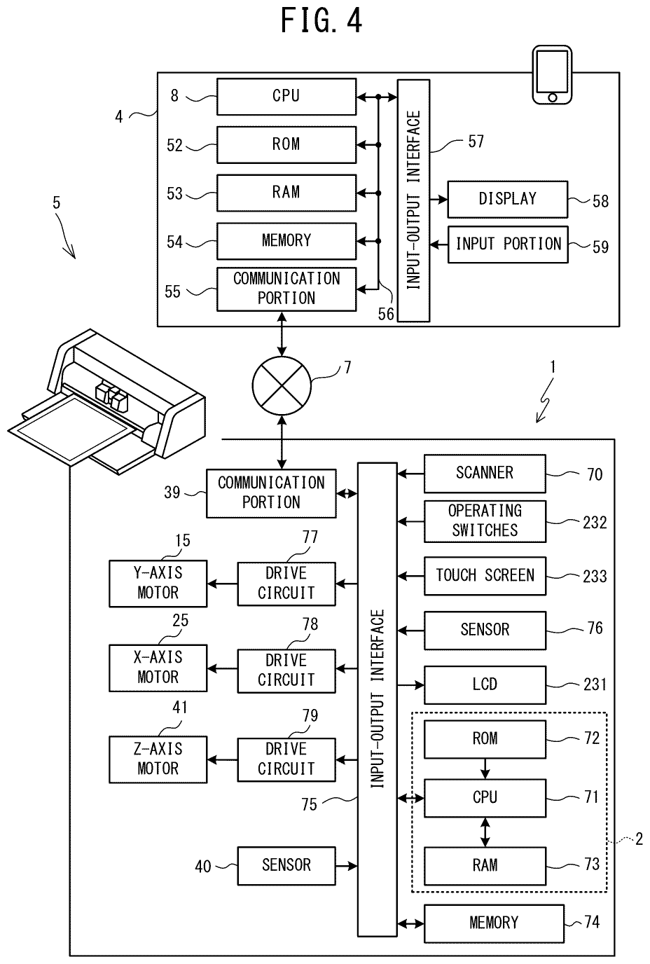

The second conveyor 2C and the first conveyor 2D are configured to move in the front-rear direction and the left-right direction relative to the cutting object 9 placed on the platen 2B and a blade mount 3B. The second conveyor 2C and the first conveyor 2D are configured to move in the front-rear direction and the left-right direction relative to the cutting object 9 placed on the platen 2B and a blade mount 3B. The second conveyor 2C moves the blade mount 3B and the cutting object 9 placed on the platen 2B relatively in the sub-scanning direction orthogonal to the main scanning direction. The sub-scanning direction of the present embodiment is the front-rear direction. The second conveyor 2C of the present disclosure is provided with a driven roller 24, a drive roller (not shown in the drawings), and a Y-axis motor 15 (refer to FIG. 4). The driven roller 24 is rotatably supported inside the main body cover 2A and further to the front than the platen 2B. The drive roller faces the driven roller 24 from below, and rotates in accordance with the driving of the Y-axis motor 15. In the state R1, the second conveyor 2C clamps, between the driven roller 24 and the drive roller, left and right end portions of the rectangular-shaped object holder 90 holding the cutting object 9. The second conveyor 2C can convey the object holder 90 in the front-rear direction (also referred to as a “Y direction”), as a result of the drive roller rotating in a state in which the object holder 90 holds the cutting object. In other words, the second conveyor 2C can convey the cutting object 9 held by the object holder 90 in the front-rear direction. When in the state R2, the second conveyor 2C sandwiches both the left and right end portions of the cutting object 9 between the driven roller 24 and the drive roller. The second conveyor 2C is configured to convey the cutting object 9 in the front-rear direction by the drive roller rotating in this state.

The first conveyor 2D is configured to move the carriage 3 in the left-right direction (hereinafter also referred to as an “X direction”). The first conveyor 2D is provided with a guide rail 26, an X-axis motor 25 (refer to FIG. 4), and the like. The guide rail 26 is fixed inside the main body cover 2A and extends in the left-right direction. The carriage 3 can move in the X direction along the guide rail 26, and is supported by the guide rail 26. The rotational movement of the X-axis motor 25 is converted into motion in the X direction, and this motion is transmitted to the carriage 3. When the X-axis motor 25 is driven forward or in reverse, the carriage 3 is moved in the leftward direction or the rightward direction.

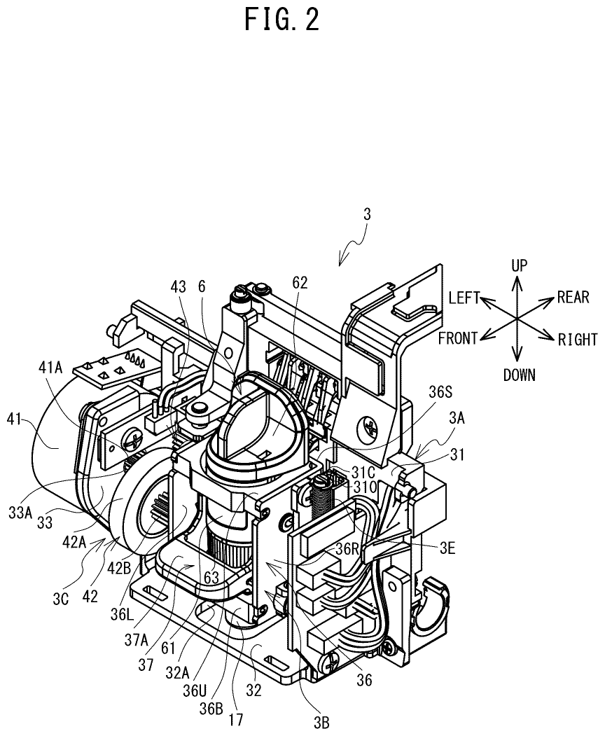

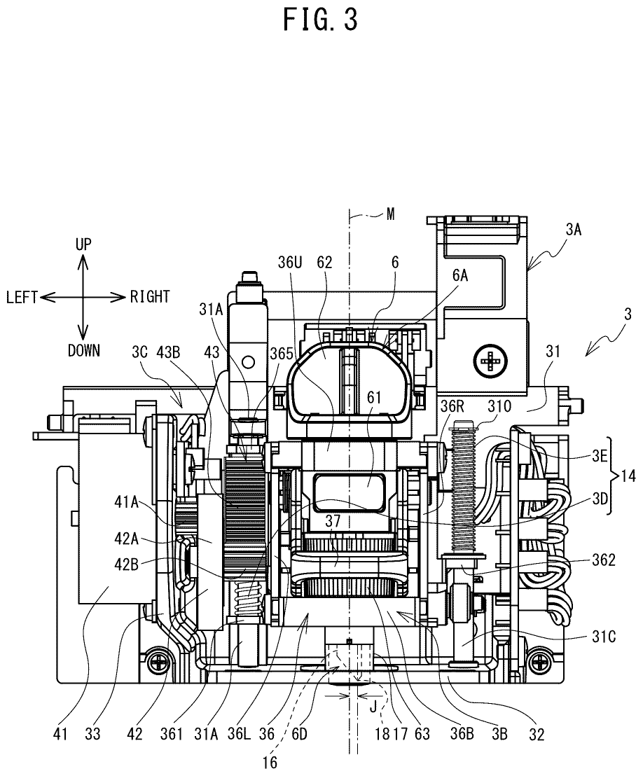

As shown in FIG. 2 and FIG. 3, the carriage 3 is provided with a support body 3A, the blade mount 3B, a third conveyor 3C, a pressure change mechanism 14, and the like. Portions of the carriage 3 apart from a portion to which the holder 6 is mounted are covered by a cover 30 shown in FIG. 1A and FIG. 1B. In FIG. 2 and FIG. 3, the cover 30 is omitted. The support bodies 3A support the blade mount 3B, the third conveyor 3C, the pressure change mechanism 14, and the like. The support body 3A includes base portions 31 to 33 that are each plate-shaped. The base portion 31 is orthogonal to the front-rear direction. The base portion 31 is coupled to the guide rail 26 (refer to FIG. 1A) at a rear surface thereof. The base portion 31 is supported by the guide rail 26 such that the base portion 31 can move in the left-right direction. As shown in FIG. 3, support shafts 31A and 31C are provided at positions separated from the base portion 31 to the front thereof. The support shafts 31A and 31C each have a circular cylindrical shape, and extend in the up-down direction. As shown in FIG. 3, the support shaft 31A is provided in the vicinity of the left end portion of the base portion 31. A spring 3D of the pressure change mechanism 14 (to be described later) is wound around the support shaft 31A. The support shaft 31A supports a rack gear 43 to be described later, such that the rack gear 43 can move in the up-down direction. The support shaft 31C is provided in the vicinity of the right end portion of the base portion 31. A spring 3E of the pressure change mechanism 14 (to be described later) is wound around the support shaft 31C. As shown in FIG. 2 and FIG. 3, the base portion 32 is orthogonal to the up-down direction, and extends to the front from the lower end portion of the base portion 31. A through hole 32A is provided in the base portion 32 so as to penetrate the base portion 32 in the up-down direction. The base portion 33 is orthogonal to the left-right direction, and extends to the front from a position further to the left than the support shaft 31A of the base portion 31. A portion of the third conveyor 3C to be described later is supported by the base portion 33.

The cutting blade 16 has the blade lower end 18 that is a lower end of the cutting blade 16 in a position away from an axis M extending in the up-down direction orthogonal to both the front-rear direction and the left-right direction. The blade mount 3B is disposed, from among support body 3A, to the front of the base portion 31, above the base portion 32, to the left of the support shaft 31C, and to the right of the support shaft 31A. The blade mount 3B includes a holding body 36 and a lever 37. The holding body 36 holds the holder 6 in the state in which the holder 6 is mounted to the blade mount 3B. The lever 37 fixes the holder 6 in the state of being held by the holding body 36, such that the holder 6 cannot be removed. The blade mount 3B is configured to mount the cutting blade 16.

As shown in FIG. 2, the holding body 36 includes side plate portions 36S, 36R, and 36L, an upper plate portion 36U, and a bottom plate portion 36B. The side plate portion 36S is disposed to the front of the base portion 31 of the support body 3A, and is orthogonal to the front-rear direction. The side plate portion 36S is coupled to the base portion 31 such that the side plate portion 36S can move in the up-down direction. In this way, the blade mount 3B is supported such that the blade mount 3B can move in the up-down direction with respect to the support body 3A. The side plate portion 36R extends toward the front from the right end portion of the side plate portion 36S. The side plate portion 36L extends toward the front from the left end portion of the side plate portion 36S. The side plate portions 36R and 36L are each orthogonal to the left-right direction. The upper plate portion 36U is provided on the upper end portions of each of the side plate portions 36S, 36R, and 36L. The bottom plate portion 36B is provided on the lower end portions of each of the side plate portions 36S, 36R, and 36L. The upper plate portion 36U and the bottom plate portion 36B are each orthogonal to the up-down direction. The front end portion of the holding body 36 is open.

A circular through hole is formed in the upper plate portion 36U so as to penetrate the upper plate portion 36U in the up-down direction. A circular through hole is formed in the bottom plate portion 36B so as to penetrate the bottom plate portion 36B in the up-down direction. In a state in which the holder 6 is held by the holding body 36, the holder 6 is inserted through the through hole of the upper plate portion 36U and the through hole of the bottom plate portion 36B. In this state, the upper end portion of the holder 6 protrudes further upward than the upper plate portion 36U, and the lower end portion of the holder 6 protrudes further downward than the bottom plate portion 36B.

As shown in FIG. 3, a movable plate portion 361 is provided at the lower end portion of the side plate portion 36L, and a movable plate portion 365 is provided at the upper end portion of the side plate portion 36L. The movable plate portions 361 and 365 extend to the left from the left surface of the side plate portion 36L, and are orthogonal to the up-down direction. Through holes are formed in the movable plate portions 361 and 365 so as to penetrate the movable plate portions 361 and 365 in the up-down direction. The support shaft 31A of the support body 3A is inserted into the through holes of the movable plate portions 361 and 365. A movable plate portion 362 is provided on the side plate portion 36R. The movable plate portion 362 extends to the right from the right surface of the side plate portion 36R, and is orthogonal to the up-down direction. A through hole is formed in the movable plate portion 362 so as to penetrate the movable plate portion 362 in the up-down direction. The support shaft 31C of the support body 3A is inserted into the through hole of the movable plate portion 362.

As shown in FIG. 2, the lever 37 is slidably supported by the side plate portions 36R and 36L of the holding body 36. The lever 37 includes a plate-shaped grip portion 37A that is long in the left-right direction. In a state in which the lever 37 has slid in a direction in which the grip portion 37A moves downward, the holder 6 that is held by the holding body 36 is fixed. In this state, the holder 6 cannot be removed from the holding body 36. On the other hand, in a state in which the lever 37 has slid in a direction in which the grip portion 37A moves upward, the state of the holder 6 being fixed to the holding body 36 is released. Thus, in this state, the holder 6 can be removed from the holding body 36.

The third conveyor 3C is configured to move the blade mount 3B in the up-down direction perpendicular to the main scanning direction and the sub-scanning direction. The third conveyor 3C is controlled by a processor 2 and moves the blade mount 3B in the downward direction in which the blade mount 3B approaches the platen 2B, and in in the upward direction in which the blade mount 3B separates from the platen 2B. By the blade mount 3B moving downward, the blade mount 3B approaches the cutting object 9 placed on the platen 2B. On the other hand, by the platen 2B moving upward, the blade mount 3B separates from the cutting object 9 placed on the platen 2B.

As shown in FIG. 2 and FIG. 3, the third conveyor 3C includes a Z-axis motor 41, a gear unit 42, a rack gear 43, and the like. The Z-axis motor 41 is disposed to the left of the base portion 33 of the support body 3A, and is fixed to the support body 3A by the base portion 33. A rotation shaft of the Z-axis motor 41 extends to the right and penetrates, to the right, a hole 33A formed in the base portion 33. A gear 41A is provided at the rotation shaft of the Z-axis motor 41. The gear 41A is disposed to the right of the base portion 33.

The gear unit 42 includes an internal gear 42A and a pinion gear 42B. The internal gear 42A has a circular plate shape, and is orthogonal to the left-right direction. A circular recessed portion, which is recessed to the right, is formed in the left side of the internal gear 42A. Teeth are formed on the inner side surface of the recessed portion. The pinion gear 42B is provided on the right surface of the internal gear 42A. The diameter of the pinion gear 42B is smaller than the diameter of the internal gear 42A. Positions of rotational centers of each of the internal gear 42A and the pinion gear 42B are aligned with each other, and extend in the left-right direction. Hereinafter, the rotational centers of each of the internal gear 42A and the pinion gear 42B are referred to as a “rotational center of the gear unit 42.” The internal gear 42A and the pinion gear 42B rotate integrally with each other.

The gear unit 42 is provided to the right of the base portion 33 of the support body 3A, and is rotatably fixed to the base portion 33. The rotational center of the gear unit 42 is positioned below the rotational shaft of the Z-axis motor 41. The gear 41A provided on the rotational shaft of the Z-axis motor 41 is inserted, from the left, into the recessed portion formed in the left surface of the internal gear 42A. The gear 41A meshes with the teeth provided on the inner side surface of the internal gear 42A. The drive force of the Z-axis motor 41 generated in accordance with the Z-axis motor 41 being driven and the gear 41A rotating is transmitted to the gear unit 42 via the gear 41A and the internal gear 42A. In this way, the pinion gear 42B of the gear unit 42 also rotates.

The rack gear 43 is provided to the rear of the pinion gear 42B. The rack gear 43 includes a rectangular column-shaped base that extends in the up-down direction. The rack gear 43 includes gear teeth 43B on the front surface of the base. The rack gear 43 further includes a through hole in the base that penetrates the base in the up-down direction. The support shaft 31A fixed to the support body 3A is inserted into that through hole. The rack gear 43 can move up and down along the support shaft 31A. The gear teeth 43B of the rack gear 43 mesh with the pinion gear 42B. The rack gear 43 moves in the up-down direction in accordance with the rotation of the pinion gear 42B.

The pressure change mechanism 14 is configured to change a pressure, in the downward direction, applied to the blade mount 3B. The pressure change mechanism 14 includes the springs 3D and 3E. The spring 3D is positioned below the rack gear 43. The spring 3D is a compression coil spring, and is wound in the vicinity of the lower end portion of the support shaft 31A. The upper end portion of the spring 3D is coupled to the lower end portion of the rack gear 43. The lower end portion of the spring 3D is coupled to the movable plate portion 361 of the blade mount 3B. The spring 3D is interposed between the rack gear 43 and the movable plate portion 361 of the blade mount 3B, and urges the rack gear 43 upward. In this way, the upper end portion of the rack gear 43 comes into contact, from below, with the movable plate portion 365 of the blade mount 3B, and presses the movable plate portion 365 upward. When the Z-axis motor 41 of the third conveyor 3C is driven, the spring 3D moves the blade mount 3B in the up-down direction in conjunction with the movement in the up-down direction of the rack gear 43. Further, when the spring 3D is compressed in accordance with the downward movement of the rack gear 43, the spring 3D applies a downward pressure on the blade mount 3B.

The spring 3E is a compression coil spring, and is wound around the support shaft 31C. A fixing washer 310 is fixed to the upper end portion of the support shaft 31C. The upper end portion of the spring 3E is in contact, from below, with the fixing washer 310. The lower end portion of the spring 3E is coupled to the movable plate portion 362 of the blade mount 3B. The spring 3E is interposed between the fixing washer 310 and the movable plate portion 362 of the blade mount 3B, and applies a downward pressure to the blade mount 3B. Regardless of a driving state of the Z-axis motor 41 of the third conveyor 3C, the spring 3E constantly applies the downward pressure to the blade mount 3B.

The holder 6 will be explained with reference to FIG. 1A to FIG. 3. The holder 6 is used in a state of being mounted to the blade mount 3B, and cuts the cutting object 9 using the cutting blade 16. The holder 6 includes a housing 6A made of resin, the cutting blade 16, a cover 17, and a second spring 6F (refer to FIG. 10). The housing 6A includes a circular cylindrical portion 61, a lid portion 62, and a screw cap 63. The cylindrical portion 61 extends the up-down direction. The center of the circular cylindrical portion 61 coincides with the axis M of the cutting blade 16. The lid portion 62 closes the opening of the upper end portion of the circular cylindrical portion 61. The screw cap 63 is fixed by being screwed onto the circular cylindrical portion 61. The screw cap 63 is removed from the housing 6A when replacing the cutting blade 16. In the state in which the holder 6 is mounted to the blade mount 3B, the housing 6A is held by the blade mount 3B. As shown in FIG. 2, the circular cylindrical portion 61 fits into the through hole of the upper plate portion 36U of the blade mount 3B. The screw cap 63 of the housing 6A fits into the through hole of the bottom plate portion 36B of the blade mount 3B. The upper end of the circular cylindrical portion 61 is disposed above the upper plate portion 36U of the blade mount 3B. As shown in FIG. 3, the lower end portion of the screw cap 63 of the housing 6A protrudes further downward than the lower end of the bottom plate portion 36B. The second spring 6F is a compression coil spring, and is extendable and contractable in the up-down direction.

The blade edge of the cutting blade 16 is inclined in a direction intersecting with an extending plane of the platen 2B and the axis M, with the blade lower end 18 as the angled portion. The cutting blade 16 has the blade lower end 18 in a position away from the axis M by a distance J shown in FIG. 3. That is, the blade lower end 18 of the cutting blade 16 is eccentric with respect to the axis M. The cover 17 protrudes downward from the lower end of the circular cylindrical portion 61 and has a cylindrical shape through which the cutting blade 16 is inserted. The second spring 6F is provided to apply downward pressure on the cutting blade 16 of a cutting body 6D.

As shown in FIG. 3, the highest position within the movable range in the up-down direction of the blade mount 3B will be referred to as a raised position. When the blade mount 3B is in the raised position, the blade lower end 18 of the cutting blade 16 of the holder 6 mounted to the blade mount 3B protrudes slightly below the base portion 32, and is separated upward from the cutting object 9 placed on the platen 2B of the cutting device 1 in the state R2, and the cutting object 9 placed on the platen 2B of the cutting device 1 via the object holder 90 in the state R1. The blade lower end 18 of the cutting blade 16 is positioned above the lower end of the cover 17.

In the state in which the blade mount 3B is disposed at the raised position, the spring 3E is compressed between the fixing washer 310 at the upper end portion thereof and the movable plate portion 362 at the lower end portion thereof. Thus, the spring 3E applies the downward pressure to the movable plate portion 362 of the blade mount 3B. The blade mount 3B receives the downward force from the spring 3E via the movable plate portion 362. On the other hand, the rotation of the pinion gear 42B that meshes with the rack gear 43 is suppressed by the rotation load of the Z-axis motor 41, and thus, the movement of the rack gear 43 in the up-down direction is suppressed. As a result, the downward movement of the movable plate portion 365 of the blade mount 3B, which is in contact with the upper end portion of the rack gear 43, is also suppressed. Thus, even in the state of receiving the downward force from the spring 3E, the blade mount 3B does not move downward and is stationary.

When cutting the cutting object 9 using the cutting blade 16, the processor 2 (refer to FIG. 4) of the cutting device 1 drives the Z-axis motor 41, and rotates the gear 41A. In accordance with the rotation of the gear 41A, the internal gear 42A and the pinion gear 42B of the gear unit 42 rotate integrally. In this way, the rack gear 43 that meshes with the pinion gear 42B moves downward. In accordance with the downward movement of the rack gear 43, the spring 3D coupled to the lower end portion of the rack gear 43 also moves downward and does not contract. Note that the blade mount 3B is in contact with the upper end portion of the rack gear 43 via the movable plate portion 365, and is coupled to the lower end portion of the spring 3D via the movable plate portion 361. Thus, the blade mount 3B moves downward from the raised position in accordance with the movement of the rack gear 43.

In accordance with the downward movement of the blade mount 3B, the holder 6 also moves downward. The cutting blade 16 of the holder 6 gradually approaches the cutting object 9 positioned below the cutting blade 16, and the cover 17 and the cutting blade 16 come into contact with the cutting object 9 in this order. At this time, since the cutting blade 16 is in contact with the cutting object 9, an upward pressure acts on the blade mount 3B via the holder 6. By continuously driving the Z-axis motor 41, the rack gear 43 moves further downward. At this time, the spring 3E applies a downward force to the blade mount 3B via the movable plate portion 362.

There is a case in which the cutting object 9 is hard, and it is not possible to cause the cutting blade 16 to penetrate the cutting object 9 using the force applied by the spring 3E. At this time, the downward movement of the blade mount 3B is suppressed by the upward force received by the blade mount 3B from the cutting object 9 via the holder 6. When the pinion gear 42B rotates further in this state, the rack gear 43 moves further downward. In this way, the upper end portion of the rack gear 43 separates from the movable plate portion 365, and the rack gear 43 moves downward while compressing the spring 3D. The spring 3D applies the downward force that is stronger than the spring 3E, to the blade mount 3B via the movable plate portion 361.

Referring to FIG. 4, a description will be provided on an electrical configuration of the cutting system 5. As shown in FIG. 4, the cutting system 5 is provided with the cutting device 1 and a mobile terminal 4. The cutting device 1 includes a CPU 71, a ROM 72, a RAM 73, a communication portion 39, and an input/output (“I/O”) interface 75. The CPU 71 is electrically connected to the ROM 72, the RAM 73, the communication portion 39, and the I/O interface 75. The CPU 71, the ROM 72, and the RAM 73 serve as the processor 2 that mainly controls the cutting device 1. The ROM 72 stores various programs for operating the cutting device 1. The programs include, for example, a program for enabling the cutting device 1 to execute cutting device processing and cutting device processing described below. The RAM 73 is configured to temporarily store various programs and data, setting values input using one or more of the operating switches 232, and calculation results obtained by the CPU 71 in calculation processing. The processor 2 is configured to control the first conveyor 2D, the second conveyor 2C, and the third conveyor 3C. The communication portion 39 is an interface for connecting the cutting device 1 to a network 7. The CPU 71 is configured to transmit and receive, via the communication portion 39, data to and from other devices (e.g., the mobile terminal 4) that connect to the network 7. A scanner 70, memory 74, the operating switches 232, the touch screen 233, a sensor 76, the sensor 40, the LCD 231, and drive circuits 77 to 79 are connected to the I/O interface 75. The memory 74 may be a nonvolatile storage device that stores, for example, various parameters.

The scanner 70 is used for processing to detect the presence of the object holder 90 by reading a marker on the object holder 90. The scanner 70 is formed, for example, by a contact image sensor (CIS), and has a line sensor consisting of a plurality of image sensors aligned in the left-right directions, a light source such as a lamp, and a lens. The scanner 70 is positioned to the rear of the guide rail 26 and extends in the left-right directions with the length approximately the same as the width dimension of the object holder 90, and is arranged with a reading surface facing downward. The sensor 76 is configured to detect a leading end of the object holder 90 set on the platen 2B. A detection signal output by the sensor 76 is input to the processor 2. The sensor 40 is configured to output a signal indicating the position of the blade mount 3B in up-down direction. In the present embodiment, the processor 2 is configured to determine, based on an output of the sensor 40, the position of the blade mount 3B in up-down direction (hereinafter, also referred to as the height of the blade mount 3B) with reference to the position of the platen 2B. Nevertheless, in other embodiment, for example, another suitable reference may be used for determining the position of the blade mount 3B in the up-down direction. The processor 2 is configured to control the LCD 231 to display one or more images thereon. The LCD 231 is configured to display thereon various instructions. The drive circuits 77 to 79 are configured to drive the Y-axis motor 15, the X-axis motor 25, and the Z-axis motor 41, respectively. The processor 2 is further configured to, based on cutting line data, control the Y-axis motor 15, the X-axis motor 25, and the Z-axis motor 41 to perform automatic cutting on the cutting object 9 placed on the object holder 90. The cutting line data includes coordinate data used for controlling the second conveyor 2C and the first conveyor 2D. The coordinate data may be represented by a cutting coordinate system defined within a cutting area. The coordinate data includes relative positions of end points of each of a plurality of line segments representing a pattern. In the present embodiment, an origin of the cutting coordinate system may be defined at a left-rear corner of the rectangular cutting area. The right-left direction may be defined as the X-axis direction, and the front-rear direction may be defined as the Y-axis direction.

The mobile terminal 4 is a well-known smartphone. The mobile terminal 4 may also be a tablet-type terminal device. The mobile terminal 4 is provided with a CPU 8, ROM 52, RAM 53, memory 54, a communication portion 55, and an input-output interface 57. The CPU 8 is a processor and controls the mobile terminal 4. The CPU 8 electrically connects the ROM 52, the RAM 53, the memory 54, the communication portion 55, and the input-output interface 57 via a bus 56. A boot program and BIOS and the like are stored in the ROM 52. Temporary data is stored in the RAM 53. The memory 54 is a non-volatile storage device. Various setting values necessary to execute processing, described later, are stored in the memory 54. The communication portion 55 is an interface for connecting the mobile terminal 4 to the network 7. The CPU 8 is configured to transmit and receive, via the communication portion 55, data to and from other devices (for example, the cutting device 1) connected to the network 7. The input-output interface 57 is connected to a display 58 and an input portion 59. The display 58, is, for example, a liquid crystal display. The input portion 59 is, for example, a touch screen, and is used when inputting various instructions.

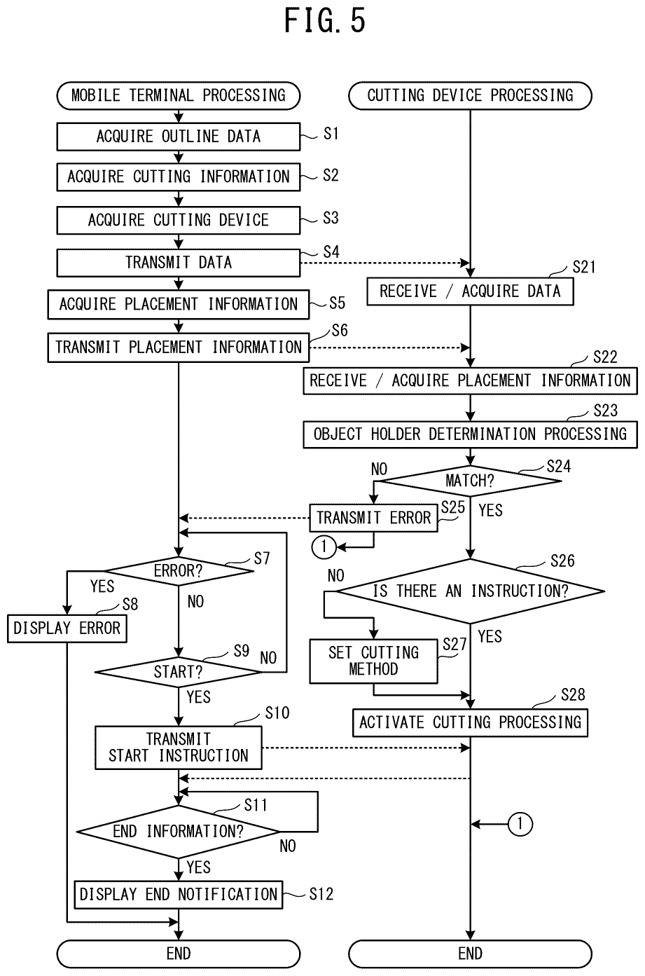

Mobile terminal processing and cutting device processing executed by the cutting system 5 will now be described using first to fourth specific examples, with reference to FIG. 5 to FIG. 12. The mobile terminal processing is processing executed by the mobile terminal 4, in which, when a user inputs a start instruction via the input portion 59, the CPU 8 of the mobile terminal 4 reads a program stored in the memory 54 to the RAM 53 and executes the mobile device processing in accordance with the instructions included in the program. The program stored in the memory 54 includes instructions that, when executed by the CPU 8, instruct CPU 8 to perform the following processes. The cutting device processing is processing executed by the processor 2 of the cutting device 1, in which, when a power supply of the cutting device 1 has been turned on, the processor 2 reads a program stored in the memory 74 into the RAM 73, and executes the cutting device processing in accordance with the instructions included in the program. The program stored in the memory 74 includes instructions that, when executed by the processor 2, instruct the processor 2 to perform the following processes.

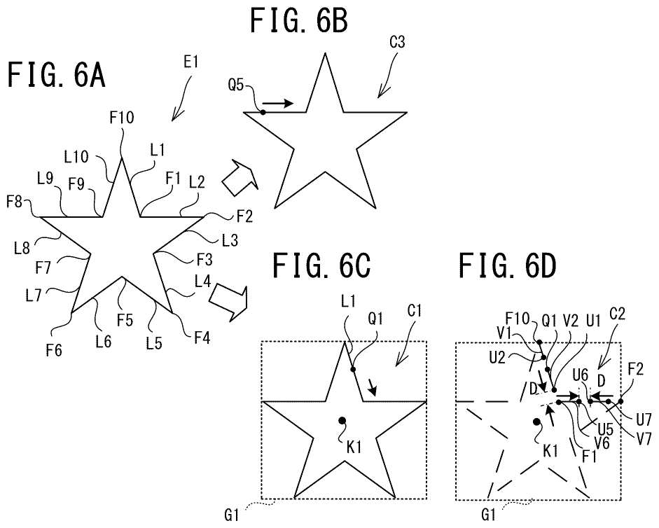

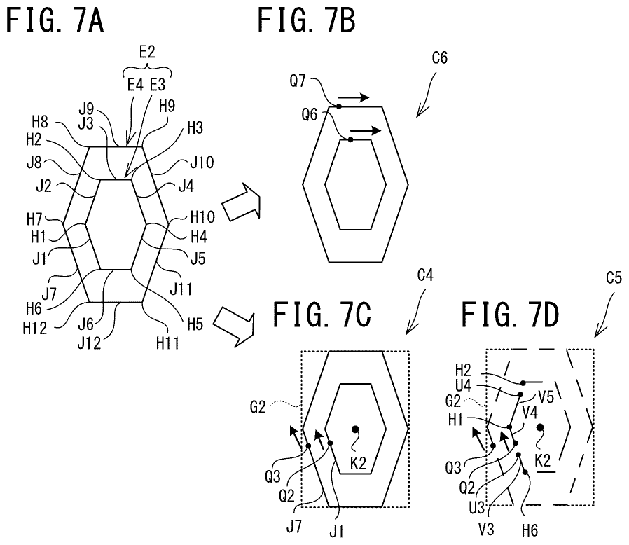

As shown in FIG. 6A to FIG. 6D, the first specific example is a case in which a cutting line C3 is formed in the cutting object 9 based on a pattern E1, and the second specific example is a case in which cutting lines C1 and C2 are formed in the cutting object 9 based on the pattern E1. The pattern E1 is a star-shaped pattern formed by ten line segments L1 to L10. As shown in FIG. 7A to FIG. 7D, the third specific example is a case in which a cutting line C6 is formed in the cutting object 9 based on a pattern E2, and the fourth specific example is a case in which cutting lines C4 and C5 are formed in the cutting object 9 based on the pattern E2. The pattern E2 is an O-shaped pattern shaped like the letter O, formed by a hexagonal pattern E3 formed by six line segments J1 to J6, and a hexagonal pattern E4 formed by six line segments J7 to J12 arranged to the outside of the pattern E3. The left-right direction and up-down direction in FIG. 6A to FIG. 7D correspond to the main scanning direction and the sub-scanning direction, respectively, of the cutting device 1.

As shown in FIG. 5, in the mobile terminal processing, the CPU 8 acquires outline data indicating the outline of the pattern to be cut from the cutting object 9 (S1). In the first and second specific examples, the CPU 8 acquires the outline data indicating the outline of the pattern E1. In the third and fourth specific examples, the CPU 8 acquires the outline data indicating the outline of the pattern E2. The outlines of the patterns include a plurality of line segments, so the outline data indicates a plurality of line segments that make up the outlines of the patterns.

The CPU 8 acquires cutting information specifying the cutting method of the cutting object 9 (S2). The user of the cutting system 5 selects one of the cutting methods from among a plurality of types of cutting methods set in advance, displayed on the display 58. The plurality of types of cutting methods of the present embodiment are two types, i.e., “normal” and “with joint”. “Normal” is a method by which the cutting object 9 is cut along the outline of the pattern by the cutting blade 16. When the cutting object 9 is cut by the “normal” cutting method, a third cutting line, which is a cut passing through the cutting object 9 in the thickness direction, is formed along the outline of the pattern in the cutting object 9 after cutting, and the pattern is separated from the cutting object 9 if the outline of the pattern is circular. “With joint” is a cutting method in which a first cutting line and a second cutting line are formed in order in the cutting object 9 by the cutting blade 16 along the outline of the pattern, without the cutting blade 16 passing completely through in the thickness direction at a portion of the outline of the pattern, such that that portion of the outline of the pattern remains attached to the cutting object 9 after cutting. The first cutting line is a groove-shaped cut that follows the outline of the pattern. That is, the first cutting line is a cut that does not pass completely through the cutting object 9 in the thickness direction. The second cutting line is a cut that passes completely through the cutting object 9 in the thickness direction along a portion of the outline after the first cutting line has been formed. When the cutting method is “with joint”, the pattern after cutting is not separated from the cutting object 9 even if the outline of the pattern is circular, but because the first cutting line is formed in the outline of the pattern and the second cutting line that passes completely vertically through is formed at a portion of the outline, the user is able to easily detach the cut pattern from the cutting object 9 at the desired timing. When the cutting method is “with joint”, the pressure applied to the cutting object 9 when forming the second cutting line can be reduced compared to when the first cutting line is not formed, so this method is well suited for cutting the cutting object 9 when the object holder 90 is not used. In the first and third specific examples, the “normal” cutting method is acquired as the cutting method. In the second and fourth specific examples, the “with joint” cutting method is acquired as the cutting method.

The CPU 8 acquires information specifying the cutting device 1 to be used for cutting the cutting object 9 (S3). The mobile terminal 4 is configured to connect to a plurality of the cutting devices 1. If a plurality of the cutting devices 1 are registered as the cutting device 1, the user of the cutting system 5 selects the desired cutting device 1 from the plurality of cutting devices 1 displayed on the display 58. At S3, for example, the CPU 8 acquires a communication address of the cutting device 1. The CPU 8 then transmits the outline data acquired at S1 and the cutting information acquired at S2 to the cutting device 1 acquired at S3 (S4).

The processor 2 of the cutting device 1 receives the data transmitted from the mobile terminal 4 (S21). At S21, the processor 2 receives or acquires the outline data indicating the outline of the pattern, and the cutting information transmitted from the mobile terminal 4. At S21, the processor 2 may also acquire the outline data and the cutting information input by the user via the operating switches 232 or the touch screen 233. The cutting device 1 of the present embodiment is able to automatically set the cutting method, so the cutting information need not be received or acquired at S21.

The CPU 8 acquires placement information input by the user via the input portion 59 (S5). The placement information indicates whether the object holder 90 is to be used, i.e., whether the cutting object 9 is to be cut by the cutting blade 16 while the cutting object 9 is placed on the object holder 90. Normally, with the “normal” cutting method, “use the object holder 90” is set as the placement information. With the “with joint” cutting method, either “use the object holder 90” or “do not use the object holder 90” may be set as the placement information. In the first, third and fourth specific examples, “use the object holder 90” is acquired as the placement information. In the second specific example, the “with joint” cutting method is acquired as the cutting method, and “do not use the object holder 90” is acquired as the placement information. The CPU 8 then transmits the placement information acquired at S5 to the cutting device 1 acquired at S3 (S6).

The processor 2 of the cutting device 1 receives the placement information transmitted from the mobile terminal 4 (S22). At S22, the processor 2 may acquire the placement information input by the user via the operating switches 232 or the touch screen 233. The processor 2 then determines whether the cutting object 9 is placed directly on the platen 2B, or whether the cutting object 9 is held by the sheet-shaped object holder 90 placed on the platen 2B (S23). The processor 2 of the present embodiment determines whether the object holder 90 is placed on the platen 2B based on an image read by the scanner 70. More specifically, when the processor 2 detects, with the sensor 76, that a sheet-shaped object is placed on the platen 2B of the cutting device 1, the processor 2 drives the second conveyor 2C to convey the sheet-shaped object, and reads the rear end portion of the sheet-shaped object with the scanner 70. If a predetermined marker is included in a predetermined region of the image read by the scanner 70, the processor 2 determines that the sheet-shaped object is the object holder 90, like the state R1 in FIG. 1A. If the predetermined marker is not included in a predetermined region of the image read by the scanner 70, the processor 2 determines that the sheet-shaped object is not the object holder 90, but is the cutting object 9, and thus determines that the cutting object 9 is placed on the platen 2B, like the state R2 of FIG. 1B.

The processor 2 determines whether the determination result at S23 and the placement information received or acquired at S22 match (S24). If the placement information received or acquired at S22 is “use the object holder 90” and the determination result at S23 indicates that the sheet-shaped object is the cutting object 9, and the placement information acquired at S22 is “do not use the object holder 90” and the determination result at S23 indicates that the sheet-shaped object is the object holder 90, the processor 2 determines that the determination result at S23 and the placement information received or acquired at S22 do not match (no at S24). In this case, the processor 2 transmits an error to the mobile terminal 4 (S25) and with this, ends the cutting device processing.

After transmitting the placement information to the cutting device 1, the CPU 8 of the mobile terminal 4 determines whether an error has been received from the cutting device 1 (S7). If an error has been received (yes at S7), the CPU 8 displays, on the display 58, an error indicating that the determination result at S23 and the placement information received or acquired at S22 do not match (S8). As a result of the processing at S8, the CPU 8 issues an error when the cutting method indicated by the cutting information is not the cutting method according to the determination result from the processing at S23 (S8). With this, the CPU 8 ends the mobile device processing.

If the placement information acquired at S22 is “use the object holder 90” and the determination result at S23 indicates that the sheet-shaped object is the object holder 90, and the placement information acquired at S22 is “do not use the object holder 90” and the determination result at S23 indicates the sheet-shaped object is the cutting object 9, the processor 2 determines that the determination result at S23 and the placement information received or acquired at S22 match (yes at S24). In this case, the processor 2 determines whether the cutting information is included in the data received or acquired at S21 (S26). If the cutting information is not included in the data at S21 (no at S26), the processor 2 sets the cutting method based on the determination result at S23 (S27). The processor 2 sets the cutting method to “normal” if it is determined at S23 that the sheet-shaped object is the object holder 90. The processor 2 sets the cutting method to “with joint” if it is determined at S23 that the sheet-shaped object is the cutting object 9. In other words, the processor 2 sets “with joint” as the cutting method for cutting the cutting object 9 in a state in which the cutting object 9 is placed directly on the platen 2B if it has been determined at S23 that the sheet-shaped object is the cutting object 9. If the cutting information is included in the data at S22 (yes at S26), or after the processing at S27, the processor 2 activates the cutting processing (S28).

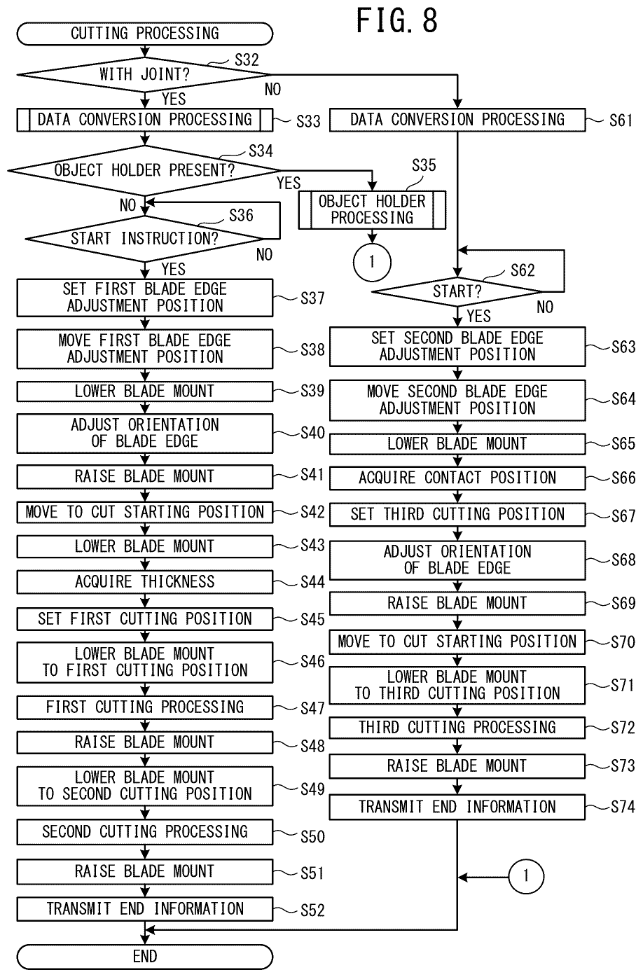

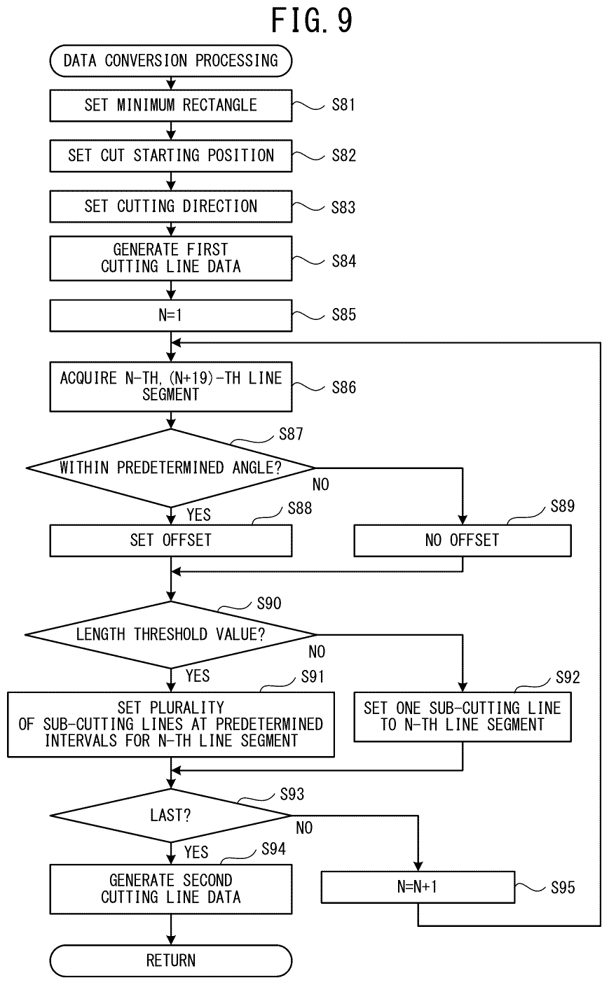

As shown in FIG. 8, in the cutting processing, the processor 2 first determines whether the cutting method was “with joint.” As in the second and fourth specific examples, if the cutting method is the “with joint” (yes at S32), the processor 2 executes data conversion processing (S33). In the data conversion processing, processing that creates first cutting line data and second cutting line data is executed based on the outline data acquired at S21. As shown in FIG. 9, the processor 2 sets the smallest rectangle that encompasses the pattern indicated by the outline data acquired at S21 (S81). The smallest rectangle has two sides extending in the main scanning direction, and two sides extending in the sub-scanning direction. For the pattern E1 of the second specific example, a smallest rectangle G1 is set, and for the pattern E2 of the fourth specific example, a smallest rectangle G2 is set.

The processor 2 sets a cut starting position on a line segment that forms the pattern (S82). The processor 2 of the present embodiment uses the positions that are a predetermined distance away from the start and end points of the line segments that make up the pattern as candidates for the cut starting position. The predetermined distance need only be set as appropriate, and may be set by the absolute distance or may be set by the relative distance. If there are a plurality of candidate cut starting positions, the processor 2 gives priority to the candidate in a position close to the center of the smallest rectangle encompassing the pattern that is set at S81 and sets that candidate as the cut starting position. In the second specific example, the processor 2 sets the cut starting position to a position Q1 close to the center K1 of the smallest rectangle G1 encompassing the pattern E1 from among the plurality of candidates. The position Q1 is a position on the line segment L1 from among the line segments L1 to L10 that make up the pattern E1. In the fourth specific example, the processor 2 sets the cut starting position for each of the patterns E3 and E4. For the pattern E3, the processor 2 sets the cut starting position to a position Q2 close to the center K2 of the smallest rectangle G2 encompassing the pattern E2 from among the plurality of candidates. The position Q2 is a position on the line segment J1 from among the line segments J1 to J6 that make up the pattern E3. For the pattern E4, the processor 2 sets the cut starting position to a position Q3 close to the center K2 of the smallest rectangle G2 encompassing the pattern E2 from among the plurality of candidates. The position Q3 is a position on the line segment J7 from among the line segments J7 to J12 that make up the pattern E4.

The processor 2 sets the cutting direction (S83). The cutting direction need only be set as appropriate, and in the present embodiment, is a direction clockwise in a plan view from the cut starting position set at S82. The point upstream in the cutting direction, from among two points, one at each end of a single line segment, is set as the starting point of the line segment, and the point that is downstream in the cutting direction is set as the end point of the line segment. The processor 2 generates the first cutting line data for forming the first cutting line, based on the outline data (S84). In the second specific example, as shown in FIG. 6C, the processor 2 generates the first cutting line data for forming the first cutting line C1 that is a groove-shaped cut, following a star-shaped outline formed by the line segments L1 to L10 indicated by the outline data. In the fourth specific example, as shown in FIG. 7C, the processor 2 generates the first cutting line data for forming the first cutting line C4 that is cut in a groove shape, following an O-shaped outline formed by the line segments J1 to J12 indicated by the outline data. In the fourth specific example, the processor 2 sets the cutting order in the order of the pattern E3 and the pattern E4, i.e., such that the cuts are made in order from the center K2 of the smallest rectangle G3, to generate the first cutting line data.

The processor 2 generates the second cutting line data for forming the second cutting line (S85 to S95). The processor 2 generates the second cutting line data for forming the second cutting line that includes a plurality of sub-cutting lines that pass vertically through the cutting object 9, positioned along the outline in accordance with a predetermined condition. The plurality of sub-cutting lines are distanced from each other in the horizontal direction orthogonal to the up-down direction. The predetermined condition of the present embodiment includes a condition in which, if the angle between any consecutive first and second line segments of the plurality of line segments is within a predetermined angle, a first sub-cutting line is positioned, on the first line segment, from a predetermined position to a first point separated from the intersection of the first and second line segments, and a second sub-cutting line connecting from the intersection point to a second point which is separated from the intersection point and different from the first point is positioned on the second line segment. The predetermined condition further includes a condition in which, if the length of any line segment of interest, from among a plurality of line segments, is equal to or longer than a predetermined length, a plurality of sub-cutting lines including a first sub-cutting line and a second sub-cutting line are positioned at predetermined intervals on the line segment of interest.

More specifically, the processor 2 sets a variable N for acquiring, in order, a plurality of lines segments that make up the pattern, to “1” (S85). The processor 2 then acquires an N-th line segment included in the outline data acquired at S21, and acquires an (N+1)-th line segment (S86). The N-th line segment and the (N+1)-th line segment are adjacent to one another. The processor 2 determines whether the angle formed by the N-th line segment and the (N+1)-th line segment acquired at S86 is within a predetermined angle (S87). The predetermined angle may be set to a preset value, e.g., within a range from 0□ to 105□. In the second specific example, the processor 2 determines the angle formed between the line segment L1 and the line segment L2 to be within the predetermined angle (yes at S87), and the processor 2 sets an offset for the N-th line segment (S88). At S88, the processor 2 sets a portion of the N-th line segment from the intersection point of the N-th line segment and the (N+1)-th line segment to a first point by a predetermined distance from the intersection point, as the offset or joint not to be cut by the cutting blade 16. In the second specific example, the processor 2 sets the joint on the end point side of the line segment for each of the intersection points F1 to F10 at S88 that is repeatedly executed. In the fourth specific example, the processor 2 sets the joint on the end point side of the line segment for intersection points H2, H3, H5, H6, H8, H9, H11, and H12 of the intersection points H1 to H12, at S88 that is repeatedly executed.

In the second specific example, the processor 2 sets a portion from the intersection point F1 of the line segment L1 and the line segment L2 to a point U1 as the offset. The point U1 is a point on the line segment L1 positioned on the upstream side in the cutting direction by a predetermined distance D from the intersection point F1. In the fourth specific example, the processor 2 determines that the angle formed by the line segment J1 and the line segment J2 is not within the predetermined angle (no at S87), and the processor 2 does not set the offset for the N-th line segment (S89). In the fourth specific example, the processor 2 does not set a joint on the end point side of the line segment for the intersection points H1, H4, H7, and H10 of the intersection points H1 to H12, at S89 that is repeatedly executed.

After S88 or S89, the processor 2 determines whether the length of the N-th line segment is greater than a threshold value. The threshold value may be set as appropriate. The threshold value is set taking into account the presence or absence of an offset, the size of the pattern, the shortest length of the line segment that can be cut with the cutting blade 16, and the cutting time, and the like. For example, the threshold value may be set at 5 mm. When the offset is set for the N-th line segment, the processor 2 may compare a value acquired by subtracting the length of the offset from the length of the N-th line segment, with the threshold value. If the length of the N-th line segment is greater than the threshold value (yes at S90), the processor 2 sets a plurality of sub-cutting lines at predetermined intervals for the N-th line segment (S91). In the second specific example, the processor 2 sets, for the line segment L1, a sub-cutting line V1 from the starting point F10 to a point U2, and a sub-cutting line V2 from the cut starting position Q1 to the point U1. In the second specific example in which the variable N is 1, an offset is set at S88, so the sub-cutting line is not set between the point U1 and the point F1, and the sub-cutting line V2 is set from the cut starting position Q1, which is at a predetermined position on the line segment L1, to the point U1 that is separated from the intersection point F1 of the line segment L1 and the line segment L2. In the second specific example, the processor 2 sets, for the line segment L2, a sub-cutting line V6 from the intersection point F1 to a point U5, and a sub-cutting line V7 from a point U6 that is separated from the point U5 by the predetermined distance D to a point U7. A joint is set between the point U7 and the intersection point F2 on the line segment L2, but a sub-cutting line is not set. Through the processing at S86 to S93, if the angle formed between the N-th line segment and the (N+1)-th line segment is within the predetermined angle, the processor 2 positions, on the N-th line segment, the first sub-cutting line from a point at a predetermined position to a first point separated from the intersection point of the N-th line segment and the (N+1)-th line segment, and positions, on the (N+1)-th line segment, the second sub-cutting line from the intersection point to a second point that differs from the first point and is separated from the intersection point. In the fourth specific example, the processor 2 sets, for the line segment J1, a sub-cutting line V3 from the starting point H6 to a point U3, and a sub-cutting line V4 from the cut starting position Q2 to the point H1. In the fourth specific example, an offset is not set at S88, so the sub-cutting line is also set for the predetermined distance D from the point H1.

If the length of the N-th line segment is equal to or less than the threshold value (no at S90), the processor 2 sets one sub-cutting line for the N-th line segment (S91). In the fourth specific example, when Nis 2, the processor 2 sets a sub-cutting line V5 from the starting point H1 to a point U4 for the line segment J2. In the fourth specific example, when Nis 2, an offset line is set at S88, so a sub-cutting line is not set from the point U4 to the point H2.

After the processing at S91 or S92, the processor 2 determines whether the variable N is the number of line segments (S93). If the variable N is not the number of line segments (no at S93), the processor 2 increments the variable N by 1 (S95), and returns the processing to S86. If the pattern includes a plurality of partial patterns, the processor 2 sets a plurality of sub-cutting lines for each of the partial patterns. The pattern E2 of the fourth specific example includes the patterns E3 and E4 as partial patterns, so processing to set a plurality of sub-cutting lines for the pattern E3 and processing to set a plurality of sub-cutting lines for the pattern E4 are executed. At S86 when the variable is a plurality of line segments, the (N+1)-th line segment may be acquired as the (N+1)-th line segment when Nis 1.

If the variable N is the number of line segments (yes at S93), the processor 2 generates the second cutting line data for forming a second cutting line that includes a plurality of sub-cutting lines that pass vertically through the cutting object 9, which was set at each at S91 and S92 (S94). In the second specific example, as shown in FIG. 6D, the processor 2 generates the second cutting line data for forming the second cutting line C2 that includes a plurality of sub-cutting lines. In the fourth specific example, as shown in FIG. 7D, the processor 2 generates the second cutting line data for forming the second cutting line C5 that includes a plurality of sub-cutting lines. With this, the processor 2 ends the data conversion processing, and returns the processing to the cutting processing of FIG. 8 (S33).

After the processing at S33, the processor 2 determines whether it has been determined in the processing at S23 that the sheet-shaped object is the object holder 90 (S34). If it has been determined in the processing at S23 that the sheet-shaped object is the object holder 90 (yes at S34), the processor 2 performs object holder processing, which will be described later (S35). If it has been determined in the processing at S23 that the sheet-shaped object is the cutting object 9 (no at S34), the processor 2 determines whether a start instruction instructing cutting to start has been acquired (S36). The processor 2 stands by until a start instruction is acquired (no at S36).

If an error is not received in the mobile terminal processing of FIG. 5 (no at S7), the CPU 8 of the mobile terminal 4 determines whether a start instruction has been detected (S9). After setting the cutting object 9 on the cutting device 1, the user of the cutting system 5 inputs, via the input portion 59, a start instruction to start processing to cut the cutting object 9. If a start instruction has not been detected (no at S9), the CPU 8 returns the processing to S7. If a start instruction has been detected (yes at S9), the CPU 8 transmits a start instruction to the cutting device 1 acquired at S3 (S10).

In the cutting processing of FIG. 8, if a start instruction has been acquired (yes at S36), the processor 2 sets a first blade edge adjustment position (S37). The first blade edge adjustment position is an adjustment position where known processing to adjust the orientation of a blade edge is executed (refer to Japanese Patent Application Laid-Open No. H2-262995, for example), and is an adjustment position when cutting is performed without using the object holder 90, which is within a blade edge adjustment region that is part of the cutting object 9, behind the outline of the pattern to be cut. The processor 2 controls the drive circuits 77 and 78 to drive the Y-axis motor 15 and the X-axis motor 25 to control the second conveyor 2C and the first conveyor 2D so as to move the blade mount 3B with respect to the cutting object 9 relatively to the first blade edge adjustment position set at S37 (S38).

The processor 2 controls the third conveyor 3C by driving the Z-axis motor 41 to move the blade mount 3B downward closer to the platen 2B in the first blade edge adjustment position at S37 (S39), and executes a known processing to adjust the orientation of the blade edge to adjust the orientation of the cutting blade 16 within the blade edge adjustment region by controlling the second conveyor 2C and the first conveyor 2D in a state with the cutting blade 16 contacting the cutting object 9 (S40). The processor 2 controls the third conveyor 3C to move the blade mount 3B upward to the raised position (S41). The processor 2 controls the first conveyor 2D and the second conveyor 2C to move the blade mount 3B and the cutting object 9 relatively to the cut starting position set in the processing at S82 (S42). The processor 2 controls the third conveyor 3C to move the blade mount 3B downward from a first initial position in the cut starting position at S42 (S43), and acquires the thickness of the cutting object 9 (S44). The first initial position is a position where the lower end 18 of the cutting blade 16 is positioned above an object upper end 92 of the cutting object 9. The first initial position of the present embodiment is the raised position. The cutting device 1 is provided with the sensor 40 for outputting the vertical position of the blade mount 3B. The processor 2 acquires the thickness of the cutting object 9 based on the detection result of the sensor 40 when the cutting blade 16 contacts the cutting object 9 (S44). More specifically, the processor 2 acquires a position TP, which is the vertical position output by the sensor 40 when the cutting blade 16 contacts the object holder 90. The processor 2 counts, as a pressure corresponding value, the number of pulses input to the Z-axis motor 41 (the drive circuit 79) when the blade mount 3B moves in the up-down direction, and acquires the height of the blade mount 3B corresponding to the pressure corresponding value based on a signal output from the sensor 40. The processor 2 of the present embodiment moves the blade mount 3B closer to the platen 2B and acquires, as the position TP, the vertical position of the blade mount 3B when the slope of the height of the blade mount 3B with respect to the pressure corresponding value changes, as shown by the legend 81 in FIG. 10. As shown in FIG. 10, the position TP indicates an upward surface of the cutting object 9, that is, the vertical position of the object upper end 92 of the cutting object 9. The processor 2 acquires, as the thickness E of the cutting object 9, the length acquired by subtracting a vertical position PP of the platen upper surface 20 of the platen 2B from the position TP. The vertical position PP of the platen upper surface 20 of the platen 2B is stored in the memory 74. When the processor 2 detects that the slope of the height of the blade mount 3B corresponding to the pressure corresponding value has changed, the processor 2 controls the third conveyor 3C to stop the downward movement of the blade mount 3B.

The processor 2 sets a first cutting position P1 based on the thickness acquired at S44 (S45). The processor 2 sets the first cutting position P1 to a position in the up-down direction between the position TP detected at S44 and the vertical position of the platen 2B. The processor 2 may set a position that is a predetermined percentage of the thickness detected at S44 below the position TP detected at S44 in the up-down direction, as the first cutting position P1. The predetermined percentage is a percentage between 30% and 70%, for example. As an example, in the present embodiment, a position one-half (50%) of the thickness detected at S44 below the position TP detected at S44 is set as the first cutting position P1.

The processor 2 controls the third conveyor 3C to move the blade mount 3B downward to the first cutting position P1 where the blade lower end 18 of the cutting blade 16 is positioned below the object upper end 92 of the cutting object 9 and above the platen upper surface 20 of the platen 2B (S46). In the processing at S46, the processor 2 controls the third conveyor 3C to move the blade mount 3B downward to the first cutting position P1 set in the processing at S45. By processing S43 through S46, the processor 2 controls the third conveyor 3C to move the blade mount 3B downward from the initial position to the first cutting position P1. The processor 2 then controls the first conveyor 2D and the second conveyor 2C to form a first cutting line, which is a groove-shaped cut that follows the outline, with the cutting blade 16 positioned at the first cutting position P1 (S47). The first cutting line is a joint that cuts a portion of the cutting object 9 in the thickness direction from the object upper end 92 of the cutting object 9 along the outline without passing completely through the cutting object 9 in the up-down direction. The object lower end 93 of the cutting object 9, at the portion where the first cutting line is formed, is not cut. In the second specific example, the first cutting line C1 is formed. The vertical position of the platen upper surface 20 of the platen 2B is approximately equal to the vertical position of the object lower end 93 of the cutting object 9 that is placed on the platen 2B.

The processor 2 controls the third conveyor 3C to move the blade mount 3B upward to the raised position (S48). The processor 2 of the present embodiment moves the blade mount 3B upward to the raised position once after the first cutting line is formed, when executing the processing to form the second cutting line after forming the first cutting line. The processor 2 may omit the processing at S48 and execute the processing to form the second cutting line without moving the blade mount 3B upward to the raised position once after forming the first cutting line.

After forming the first cutting line, the processor 2 controls the third conveyor 3C to move the blade mount 3B downward from a second initial position to the second cutting position P2 where the blade lower end 18 of the cutting blade 16 is positioned below the platen upper surface 20 of the platen 2B and is positioned in the groove 10 as shown in FIG. 10 (S49). The second initial position is a position where the lower end 18 of the cutting blade 16 is positioned above an object upper end 92 of the cutting object 9. The second initial position of the present embodiment is the same as the first initial position, and is the raised position. When the blade mount 3B is in the second cutting position P2, the cutting blade 16 is passing completely through the cutting object 9 in the up-down direction. The second cutting position P2 may be a position where the vertical position of the blade lower end 18 of the cutting blade 16 is the same as position as the platen upper surface 20 of the platen 2B, or a position that is the same as, or lower than, the vertical position of the object lower end 93 of the cutting object 9. The processor 2 controls the first conveyor 2D and the second conveyor 2C to form, with the cutting blade 16 positioned at the second cutting position P2, a second cutting line that passes completely through the cutting object 9 in the up-down direction along a portion of the outline (S50). In the processing at S50, the processor 2 controls the first conveyor 2D and the second conveyor 2C based on the second cutting line data generated at S94 and forms the second cutting line with the cutting blade 16 positioned at the second cutting position P2. At S50, a plurality of sub-cutting lines are cut individually, so at the starting point of the sub-cutting lines, the processor 2 executes processing to control the third conveyor 3C to move the blade mount 3B downward to the second cutting position P2, and at the end point of the sub-cutting lines, the processor 2 executes processing to control the third conveyor 3C to move the blade mount 3B upward to the raised position. Between the plurality of sub-cutting lines, the processor 2 controls the second conveyor 2C and the first conveyor 2D to move the cutting object 9 and the blade mount 3B relatively to the starting point of the next sub-cutting line in the cutting sequence while the blade mount 3B is in the raised position.

The processor 2 then controls the third conveyor 3C to move the blade mount 3B upward to the raised position (S51). The processor 2 transmits, to the mobile terminal 4, end information indicating that the processing to cut the cutting object 9 has been completed (S52). With this, the processor 2 ends the cutting processing.

In the mobile terminal processing in FIG. 5, the CPU 8 of the mobile terminal 4, after transmitting the start instruction (S10), determines whether end information has been received from the cutting device 1 (S11), and waits until the end information is received (no at S11). If the end information has been received (yes at S11), the CPU 8 displays a message indicating that cutting has ended on the display 58 (S12). With this, the CPU 8 ends the mobile terminal processing.

In the cutting processing in FIG. 8, in the first and third specific examples, it is determined that the cutting method is “normal” cutting method and is not “with joint” (yes at S32), so the processor 2 executes data conversion processing to generate, based on the outline data acquired at S21, third cutting line data which is normal cutting line data in which the cutting object 9 is cut away along the outline of the pattern (S61). As shown in FIG. 6B, in the first specific example, a cut starting position Q5 is set for the pattern E1, and the third cutting line data is generated to form a third cutting line C3 that will cut clockwise in a plan view from the cut starting position Q5. The cut starting position Q5 may be the same as or different than the cut starting position Q1 when the cutting method is “with joint”. The cutting direction may be the same as or different from the cutting direction when the cutting method is “with joint”. As shown in FIG. 7B, in the second specific example, cut starting positions Q6 and Q7 are set for the pattern E2, and third cutting line data is generated to form a third cutting line C6 that will cut clockwise in a plan view from the cut starting positions Q6 and Q7, respectively.

The processor 2 determines whether a start instruction has been acquired (S62), and waits until a start instruction is acquired (no at S62), just like at S36. If the processor 2 has acquired a start instruction (yes at S62), the processor 2 sets a second blade edge adjustment position (S63). The second blade edge adjustment position is an adjustment position where known processing to adjust the orientation of the blade edge is executed, and is an adjustment position when cutting is performed using the object holder 90, which is within a blade edge adjustment region that is part of the object holder 90 shown in FIG. 1A, behind the cutting object 9. The processor 2 controls the second conveyor 2C and the first conveyor 2D to move the blade mount 3B with respect to the cutting object 9 relatively to the second blade edge adjustment position set at S63 (S64).

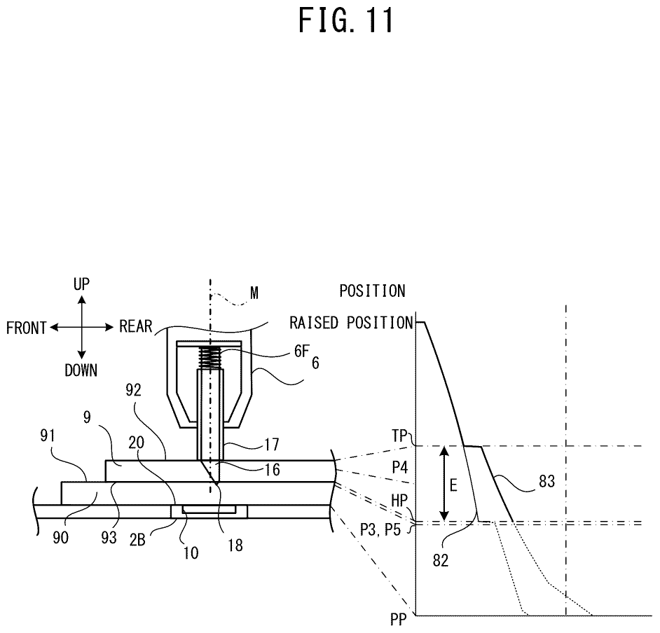

The processor 2 controls the third conveyor 3C to move the blade mount 3B downward closer to the platen 2B at the predetermined position at S2 (S65), and acquires a contact position HP that is a vertical position where the sensor 40 outputs a signal when the cutting blade 16 has contacted the object holder 90 (S66). The processor 2 counts, as a pressure corresponding value, the number of pulses input to the Z-axis motor 41 (the drive circuit 79) when the blade mount 3B moves in the up-down direction, and acquires the height of the blade mount 3B corresponding to the pressure corresponding value based on a signal output from the sensor 40. The processor 2 of the present embodiment moves the blade mount 3B closer to the platen 2B and acquires, as the contact position HP, the vertical position of the blade mount 3B when the slope of the height of the blade mount 3B with respect to the pressure corresponding value changes, as shown by the legend 82 in FIG. 11. As shown in FIG. 11, the contact position HP indicates the upward surface of the object holder 90, that is, the vertical position of a mat upper end 91 that is the upper end of the object holder 90. After it has been detected that the slope of the height of the blade mount 3B corresponding to the pressure corresponding value has changed, the processor 2 controls the third conveyor 3C to stop the downward movement of the blade mount 3B.

The processor 2 sets a third cutting position P3 based on the acquired contact position HP (S67). The processor 2 of the present embodiment sets, as the third cutting position P3, a position at which the blade mount 3B is moved downward a predetermined distance less than the thickness (length in the vertical direction) of the object holder 90 from the contact position HP acquired by the processing at S66. The thickness of the object holder 90 may be acquired based on the output of the sensor 40, or may be stored in the memory 74 or the like in advance, and is, for example, 4.0 mm. The predetermined distance may be stored in the memory 74 or the like in advance, or may be set by the user, and is, for example, 1.0 mm.

While the cutting blade 16 is in a state contacting the object holder 90 by the processing at S65, the processor 2 controls the second conveyor 2C and the first conveyor 2D, and executes known processing to adjust the orientation of the blade edge to adjust the orientation of the cutting blade 16 within the second cutting edge adjustment region (S68). The processor 2 controls the third conveyor 3C to move the blade mount 3B upward to the raised position (S69). The processor 2 controls the second conveyor 2C and the first conveyor 2D to move the cutting object 9 and the blade mount 3B relatively to the cut starting position set at S61 (S70). After executing the processing at S70, the processor 2 controls the third conveyor 3C to move the blade mount 3B downward to the third cutting position P3 where the blade lower end 18 of the cutting blade 16 is positioned below the mat upper end 91 of the object holder 90 (S71). After the processing at S71, the processor 2 controls the first conveyor 2D and the second conveyor 2C and forms a third cutting line that passes completely through the cutting object 9 in the vertical direction along the outline with the cutting blade 16 positioned at the third cutting position P3 (S72). The processor 2 controls the first conveyor 2D and the second conveyor 2C and forms the third cutting line that passes completely through the cutting object 9 in the up-down direction along the outline in accordance with the third cutting line data generated at S61 with the cutting blade 16 positioned at the third cutting position P3.

The processor 2 controls the third conveyor 3C to move the blade mount 3B upward to the raised position (S73). The processor 2 then transmits end information indicating that the processing to cut the cutting object 9 has been completed to the mobile terminal 4 (S74). With this, the processor 2 ends the cutting processing.

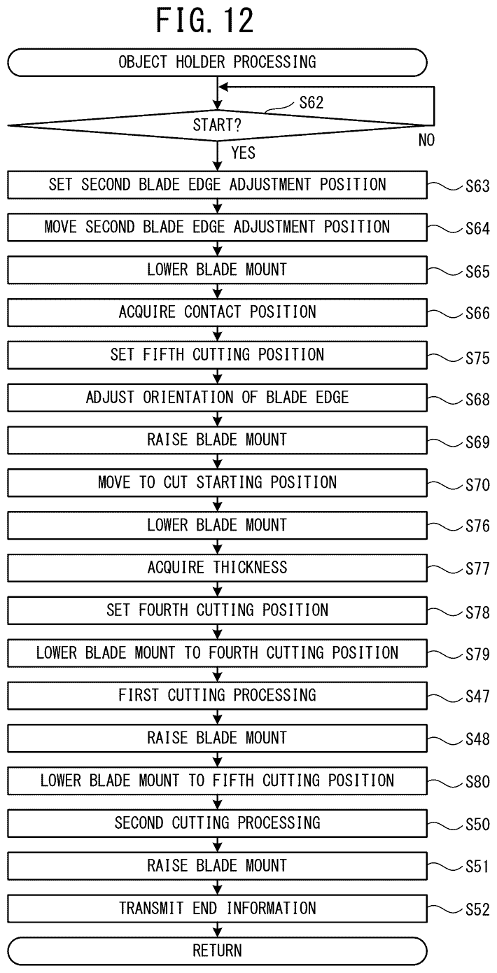

In the processing at S23, in the fourth specific example, it is determined that the sheet-shaped object is the object holder 90 (yes at S34), so the processor 2 executes the object holder processing shown in FIG. 12 (S35). In FIG. 12, steps that are the same as the steps executed in the cutting processing in FIG. 8 will be denoted by the same reference numerals. Descriptions of those steps that are the same as the steps in FIG. 8 will be omitted or simplified. As shown in FIG. 12, in the object holder processing, at S75 after S62 to S66 have been executed, a fifth cutting position P5 is set based on the contact position HP acquired at S66 (S75). The fifth cutting position P5 may be set like the third cutting position P3 set at S67, and may be set to a position that is the same as or different from the third cutting position P3. At S70 after the processing at S68 and S69, the processor 2 moves the blade mount 3B to the cut starting position set at S82, and at S76, the processor 2 controls the third conveyor 3C to move the blade mount 3B downward closer to the platen 2B at the cut starting position at S70 (S76), and acquires the thickness of the cutting object 9 (S77). The processor 2 then acquires the thickness of the cutting object 9 based on the detection result from the sensor 40 when the cutting blade 16 contacts the cutting object 9 (S77). More specifically, the processor 2 acquires a position TP that is the vertical position where the sensor 40 outputs a signal when the cutting blade 16 has contacted the cutting object 9, just like S44. The processor 2 counts, as a pressure corresponding value, the number of pulses input to the Z-axis motor 41 (the drive circuit 79) when the blade mount 3B moves in the up-down direction, and acquires the height of the blade mount 3B corresponding to the pressure corresponding value based on the signal output from the sensor 40. The processor 2 of the present embodiment moves the blade mount 3B closer to the platen 2B and acquires, as the position TP, the vertical position of the blade mount 3B when the slope of the height of the blade mount 3B with respect to the pressure corresponding value changes, as shown by the legend 83 in FIG. 11. As shown in FIG. 11, the position TP indicates the upward surface of the cutting object 9, that is, the vertical position of the object upper end 92 of the cutting object 9. The processor 2 then acquires, as the thickness E of the cutting object 9, the length acquired by subtracting the vertical position of the contact position HP acquired at S66 from the position TP. When the processor 2 detects that the slope of the height of the blade mount 3B corresponding to the pressure corresponding value has changed, the processor 2 controls the third conveyor 3C to stop the downward movement of the blade mount 3B.

The processor 2 sets a fourth cutting position P4 based on the thickness acquired at S77 (S78). The processor 2 sets the fourth cutting position P4 to a position in the up-down direction between the position TP detected at S77 and the vertical position of the mat upper end 91 of the object holder 90. The processor 2 may set a position that is a predetermined percentage of the thickness detected at S77 below the position TP detected at S77 in the up-down direction, as the fourth cutting position P4. As an example, in the present embodiment, a position one-half of the thickness detected at S77, that is, 50% of the thickness detected at S77, below the position TP detected at S77 is set as the fourth cutting position P4.

The processor 2 controls the third conveyor 3C to move the blade mount 3B downward to the fourth cutting position P4 where the blade lower end 18 of the cutting blade 16 is positioned below the object upper end 92 of the cutting object 9 and above the mat upper end 91 of the object holder 90 (S46). In the processing at S46, the processor 2 controls the third conveyor 3C to move the blade mount 3B downward to the fourth cutting position P4 set in the processing at S78. The processor 2 then controls the first conveyor 2D and the second conveyor 2C to form a first cutting line, which is a groove-shaped cut following the outline, with the cutting blade 16 positioned at the fourth cutting position P4 (S47). In the fourth specific example, the first cutting line C4 is formed. The pattern E2 of the fourth specific example includes the plurality of patterns E3 and E4, so the first cutting line for the pattern E4 is formed after first forming the first cutting line for the pattern E3 that is closer to the center K2 of the smallest rectangle G2 of the pattern E2. At the cutting end position of the pattern E3, the processor 2 executes processing to control the third conveyor 3C and move the blade mount 3B upward to the raised position. At the cut starting position Q3 of the pattern E4, the processor 2 executes processing to control the third conveyor 3C to move the blade mount 3B downward to the fourth cutting position P4. From the cutting end position of the pattern E3 to the cut starting position Q3 of the pattern E4, the processor 2 controls the second conveyor 2C and the first conveyor 2D to move the cutting object 9 and the blade mount 3B relatively to the cut starting position Q3 of the pattern E4 while the blade mount 3B is in the raised position.

The processor 2 controls the third conveyor 3C to move the blade mount 3B upward to the raised position (S48). When performing processing to form a second cutting line after forming a first cutting line, the processor 2 of the present embodiment moves the blade mount 3B upward to the raised position once after the first cutting line is formed. The processor 2 may omit the processing at the S48 and execute processing to form the second cutting line without moving the blade mount 3B to the raised position once after the first cutting line is formed.

After the first cutting line is formed, the processor 2 controls the third conveyor 3C to move the blade mount 3B downward to the fifth cutting position P5 set in the processing at S75 (S80). When the blade mount 3B is in the fifth cutting position P5, the cutting blade 16 is passing completely through the cutting object 9 in the up-down direction. The processor 2 controls the first conveyor 2D and the second conveyor 2C and forms, with the cutting blade 16 positioned at the fifth cutting position P5, a second cutting line that passes completely through the cutting object 9 in the up-down direction along a portion of the outline (S50). In the processing at S50, the processor 2 controls the first conveyor 2D and the second conveyor 2C based on the second cutting line data generated at S94 and forms the second cutting line with the cutting blade 16 positioned at the fifth cutting position P5. At S50, a plurality of sub-cutting lines are cut individually, so at the starting point of the sub-cutting lines, the processor 2 executes processing to control the third conveyor 3C to move the blade mount 3B downward to the fifth cutting position P5, and at the end point of the sub-cutting lines, the processor 2 executes processing to control the third conveyor 3C to move the blade mount 3B upward to the raised position. Between the plurality of sub-cutting lines, the processor 2 controls the second conveyor 2C and the first conveyor 2D to move the cutting object 9 and the blade mount 3B relatively to the starting point of the next sub-cutting line in the cutting sequence while the blade mount 3B is in the raised position.

The processor 2 then controls the third conveyor 3C to move the blade mount 3B upward to the raised position (S51). The processor 2 transmits, to the mobile terminal 4, end information indicating that the processing to cut the cutting object 9 has been completed (S52). With this, the processor 2 ends the object holder processing and returns the processing to the cutting processing of FIG. 8. After the processing at S35, the processor 2 ends the cutting processing at this point.

The cutting device 1 of the embodiment described above is provided with the platen 2B in which is formed the groove 10 extending in the main scanning direction, the blade mount 3B configured to mount the cutting blade 16, the first conveyor 2D that moves the sheet-shaped cutting object 9 placed on the platen 2B and the blade mount 3B relatively in the main scanning direction, the second conveyor 2C that moves the cutting object 9 placed on the platen 2B and the blade mount 3B relatively in the sub-scanning direction orthogonal to the main scanning direction, the third conveyor 3C that moves the blade mount 3B in the up-down direction orthogonal to both the main scanning direction and the sub-scanning direction, and the processor 2. The processor is configured to control the first conveyor 2D, the second conveyor 2C, and the third conveyor 3C. The processor 2 acquires the outline data indicating the outline of the pattern (S21). The processor 2 controls the first conveyor 2D and the second conveyor 2C to move the blade mount 3B and the cutting object 9 relatively to the cut starting position (S42). The processor 2 controls the third conveyor 3C to move the blade mount 3B downward to the first cutting position P1 (S46). The first cutting position P1 is a position where the blade lower end 18 of the cutting blade 16 is below the object upper end 92 of the cutting object 9, and the blade lower end 18 is above the platen upper surface 20 of the platen 2B. The processor 2 controls the first conveyor 2D and the second conveyor 2C such that the first cutting line that is a groove-shaped cut along the outline is formed by the cutting blade 16 mounted to the blade mount 3B positioned at the first cutting position P1 (S47). After forming the first cutting line, the processor 2 controls the third conveyor 3C to move the blade mount 3B downward to the second cutting position P2 (S49). The second cutting position P2 is a position where the blade lower end 18 of the cutting blade 16 is below the platen upper surface 20 of the platen 2B, and the blade lower end 18 is positioned in the groove 10. The processor 2 controls the first conveyor 2D and the second conveyor 2C such that the second cutting line that passes completely through the cutting object 9 in the up-down direction is formed along a portion of the outline by the cutting blade 16 mounted to the blade mount 3B positioned at the second cutting position P2 (S50). When cutting the cutting object 9 along the outline of the pattern, after forming the groove-shaped first cutting line, the cutting device 1 forms the second cutting line along a portion of the outline of the pattern in order to form a joint, which is a portion where the cutting object 9 is not cut completely through in the up-down direction. When forming the second cutting line, the cutting device 1 contributes to reducing the pressure applied to the cutting object 9 compared to when the first cutting line is not formed. Therefore, the processing for forming the first cutting line and the processing for forming the second cutting line of the cutting device 1 contributes to inhibiting the formation of an unintended cutting line in the cutting object 9 due to flexure of the cutting object 9 caused by pressure applied to the cutting object 9 from the cutting blade 16 during formation of the second cutting line, thereby contributing to an increase in cutting accuracy compared to known art when cutting the cutting object 9 without using the object holder 90.

The processor 2 acquires the thickness of the cutting object 9 (S44). The processor 2 sets the first cutting position P1 based on the thickness (S45). In the processing at S46, the processor 2 controls the third conveyor 3C to move the blade mount 3B downward to the first cutting position P1 set by the processing at S45. The cutting device 1 contributes to setting the first cutting position P1 in accordance with the thickness of the cutting object 9.

The cutting device 1 is provided with the sensor 40 that outputs a signal indicative of the vertical position of the blade mount 3B. The processor 2 acquires the thickness of the cutting object 9 based on the detection result from the sensor 40 when the cutting blade 16 contacts the cutting object 9 (S44). The cutting device 1 contributes to automatically acquiring the thickness of the cutting object 9 and set the first cutting position P1 in accordance with the detection result from the sensor 40.

The processor 2 generates the first cutting line data for forming the first cutting line and the second cutting line data for forming the second cutting line based on the outline data (S84 and S94). In the processing at S47, the processor 2 controls the first conveyor 2D and the second conveyor 2C based on the first cutting line data generated at S84, and forms the first cutting line with the cutting blade 16 mounted to the blade mount 3B positioned at the first cutting position P1, and in the processing at S50, the processor 2 controls the first conveyor 2D and the second conveyor 2C based on the second cutting line data generated at S94 and forms the second cutting line with the cutting blade 16 mounted to the blade mount 3B positioned at the second cutting position P2. The cutting device 1 contributes to more smoothly executing the processing for forming the first cutting line at S47 and the processing for forming the second cutting line at S50 compared to when the cutting device 1 does not generate the first cutting line data and the second cutting line data.

If there are a plurality of candidate cut starting positions, the processor 2 gives priority to the candidate in a position close to the center of the smallest rectangle encompassing the pattern and sets that candidate as the cut starting position (S82). In the processing at S42, the processor 2 controls the first conveyor 2D and the second conveyor 2C to move the blade mount 3B and the cutting object 9 relatively to the cut starting position set by the processing at S82. The cutting device 1 contributes to forming the first cutting line and the second cutting line in the cutting object 9 more stable than when the cut starting position is set giving priority to a position far from the center of the smallest rectangle encompassing the pattern.

The outline data includes a plurality of line segment data indicating each of the plurality of line segments. In the processing at S94, the processor 2 generates the second cutting line data for forming the second cutting line that is arranged along the outline in accordance with a predetermined condition and includes the plurality of sub-cutting lines that pass completely through the cutting object 9 in the up-down direction. The plurality of sub-cutting lines are all spaced apart from each other in a direction orthogonal to the downward direction, and the predetermined condition includes a condition in which the first sub-cutting line and the second sub-cutting line are arranged when the angle formed between any consecutive first and second line segments, of the plurality of line segments, is within a predetermined angle (yes at S87). The first sub-cutting line extends from a predetermined position on the first line segment to a first point separated from the intersection point of the first line segment and the second line segment. The second sub-cutting line extends on the second line segment from the intersection point to a second point that is separated from the intersection point and is different from the first point. When the angle between any consecutive first and second line segments is within a predetermined angle, the cutting device 1 contributes to stably cutting the cutting object by preventing the corners of the first and second line segments from being deformed or the pattern portion of the cutting object from being damaged when the first and second line segments are cut.

The outline data includes a plurality of line segment data indicating each of the plurality of line segments. In the processing at S94, the processor 2 generates the second cutting line data for forming the second cutting line that is arranged along the outline in accordance with a predetermined condition and includes the plurality of sub-cutting lines that pass completely through the cutting object 9 in the up-down direction. The plurality of sub-cutting lines are all spaced apart from each other in a direction orthogonal to the downward direction. The predetermined condition includes a condition in which, when the length of an arbitrary line segment of interest, from among the plurality of line segments, is equal to or longer than a predetermined length, the plurality of sub-cutting lines that include the first sub-cutting line and the second sub-cutting line are arranged at predetermined intervals on the line segment of interest. The cutting device 1 contributes to forming the second cutting line without a plurality of cutting lines being set on a short line segment stably compared to when a plurality of sub-cutting lines are set uniformly irrespective of the length of the line segment.

The processor 2 determines whether the cutting object 9 is placed directly on the platen 2B or the cutting object 9 is held by the sheet-shaped object holder 90 placed on the platen 2B (S23). If the processor 2 determines at S23 that the cutting object 9 is placed directly on the platen 2B (no at S34), then the processing at S42, the processing at S46, the processing at S47, the processing at S49, and the processing at S50 is executed. If the cutting object 9 is placed directly on the platen 2B, the cutting device 1 contributes to cutting the cutting object 9 by a cutting method appropriate when the cutting object 9 is placed directly on the platen 2B.

If it is determined in the processing at S23 that the cutting object 9 is held by the object holder 90 placed on the platen 2B (yes at S24, no at S32), then after executing the processing at S70, the processor 2 controls the third conveyor 3C to move the blade mount 3B downward to the third cutting position P3 where the blade lower end 18 of the cutting blade 16 is positioned below the mat upper end 91 of the object holder 90 (S71). After the processing at S71, the processor 2 controls the first conveyor 2D and the second conveyor 2C to form, with the cutting blade 16 mounted to the blade mount 3B placed at the third cutting position P3, the third cutting line that passes completely through the cutting object 9 in the up-down direction along the outline (S72). The cutting device 1 contributes to automatically switching between cutting methods of the cutting object 9 depending on whether the cutting object 9 is placed directly on the platen 2B or the cutting object 9 is held by the sheet-shaped object holder 90 placed on the platen 2B.

If it is determined in the processing at S23 that the cutting object 9 is held by the object holder 90 placed on the platen 2B (yes at S34), the processor 2 sets, instead of the first cutting position P1, the fourth cutting position P4 where the blade lower end 18 of the cutting blade 16 is positioned below the object upper end 92 of the cutting object 9 and the blade lower end 18 is positioned above the mat upper end 91 of the object holder 90 (S78), and sets, instead of the second cutting position P2, the fifth cutting position P5 where the blade lower end 18 of the cutting blade 16 is positioned below the mat upper end 91 of the object holder 90 (S75), and then executes the processing at S70, the processing at S79, the processing at S46, the processing at S80, and the processing at S49. The cutting device 1 contributes to automatically switching the setting method of the vertical position of the cutting blade 16 in the processing for forming the first cutting line and the vertical position of the cutting blade 16 in the processing for forming the second cutting line depending on whether the cutting object 9 is placed directly on the platen 2B or the cutting object 9 is held by the sheet-shaped object holder 90 placed on the platen 2B. If it is determined in the processing at S23 that the cutting object 9 is held by the object holder 90 placed on the platen 2B (yes at S34), then the cutting device 1 contributes to avoiding the vertical position of the cutting blade 16 from being set to the second cutting position P2 where the cutting blade 16 would pass completely through the object holder 90 in the up-down direction.

The cutting system 5 includes the cutting device 1 and mobile terminal 4. The cutting device 1 is provided with the platen 2B in which is formed the groove 10 extending bi-directionally in the main scanning direction, and the blade mount 3B configured to mount the cutting blade 16. The cutting device 1 is configured to cut the sheet-shaped cutting object 9 with the cutting blade 16. The mobile terminal 4 is configured to communicate with the cutting device 1. The mobile terminal 4 has the CPU 8, and the CPU 8 acquires the cutting information specifying the cutting method of the cutting object 9 (S2). The CPU 8 transmits the cutting information to the cutting device 1 (S4). The cutting device 1 is provide with the first conveyor 2D, the second conveyor 2C, the third conveyor 3C, and the processor 2. The first conveyor 2D moves the blade mount 3B and the cutting object 9 placed on the platen 2B relatively in the main scanning direction. The second conveyor 2C moves the blade mount 3B and the cutting object 9 placed on the platen 2B relatively in the sub-scanning direction orthogonal to the main scanning direction. The third conveyor 3C moves the blade mount 3B in the up-down direction orthogonal to both the main scanning direction and the sub-scanning direction. The processor 2 is configured to control the first conveyor 2D, the second conveyor 2C, and the third conveyor 3C. The processor 2 receives the cutting information transmitted from the mobile terminal 4 (S21). The processor 2 acquires the outline data indicating the outline of the pattern (S21). The processor 2 controls the first conveyor 2D and the second conveyor 2C to move the blade mount 3B and the cutting object 9 relatively to the cut starting position (S42). After the processing at S42, the processor 2 controls the third conveyor 3C to move the blade mount 3B downward to the first cutting position P1 at the cut starting position if the cutting information indicates a cutting method to cut the cutting object 9 with the cutting object 9 placed directly on the platen 2B (yes at S32) (S46). The first cutting position P1 is a position where the blade lower end 18 of the cutting blade 16 is below the object upper end 92 of the cutting object 9, and the blade lower end 18 is above the object lower end 93 of the cutting object 9. After the processing at S46, the processor 2 controls the first conveyor 2D and the second conveyor 2C such that the first cutting line that is a groove-shaped cut along the outline is formed by the cutting blade 16 mounted to the blade mount 3B positioned at the first cutting position P1 (S47). After the processing at S47, the processor 2 controls the third conveyor 3C to move the blade mount 3B downward to the second cutting position P2 (S49). The second cutting position P2 is a position where the blade lower end 18 of the cutting blade 16 is below the object lower end 93 of the cutting object 9, and the blade lower end 18 is positioned in the groove 10. After the processing at S49, the processor 2 controls the first conveyor 2D and the second conveyor 2C such that the second cutting line that passes completely through the cutting object 9 in the up-down direction is formed along a portion of the outline by the cutting blade 16 mounted to the blade mount 3B positioned at the second cutting position P2 (S50). When the cutting information input and transmitted from the mobile terminal 4 indicates the cutting method for cutting the cutting object 9 with the cutting object 9 placed directly on the platen 2B, the cutting system 5 contributes to executing the processing for forming the first cutting line and the processing for forming the second cutting line. When cutting the cutting object 9 along the outline of the pattern, after forming the groove-shaped first cutting line, the cutting device 1 forms the second cutting line along a portion of the outline of the pattern in order to form a joint, which is a portion where the cutting object 9 is not cut completely through in the up-down direction. When forming the second cutting line, the cutting device 1 contributes to reducing the pressure applied to the cutting object 9 compared to when the first cutting line is not formed. Therefore, the processing for forming the first cutting line and the processing for forming the second cutting line of the cutting device 1 contributes to inhibiting the formation of an unintended cutting line in the cutting object 9 due to flexure of the cutting object 9 caused by pressure applied to the cutting object 9 from the cutting blade 16 during formation of the second cutting line, thereby contributing to an increase in cutting accuracy compared to known art when cutting the cutting object 9 without using the object holder 90. The cutting system 5 contributes to inputting an instruction to the cutting device 1 from a position away from the cutting device 1 using the mobile terminal 4. In this way, the cutting system 5 contributes to improving user convenience when inputting instructions to the cutting device 1.

At least either the CPU 8 of the mobile terminal 4 or the processor 2 of the cutting device 1 determines whether the cutting object 9 is placed directly on the platen 2B or the cutting object 9 is held by the object holder 90 placed on the platen 2B (S23). If the cutting method indicated by the cutting information is not a cutting method according to the detection result of the processing at S23, the CPU 8 issues an error (S8). The processing at S8 of the cutting system 5 contributes to helping the user to know if the cutting information that was input and transmitted from the mobile terminal 4 is not a cutting method according to the detection result of the processing at S23.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The cutting device and cutting system of the present disclosure is not limited to the foregoing embodiments and may be modified in various ways without departing from the scope of the present disclosure. For example, the configuration of the cutting device 1 may be modified as appropriate. In addition to cutting with the cutting blade 16, the cutting device 1 may be configured to execute non-cutting processing such as drawing. The cutting device 1 need only be able to move the blade mount 3B and the object holder 90 relatively in the main scanning direction and the sub-scanning direction. For example, the position of the object holder 90 may be fixed, and then the blade mount 3B may be moved in the main scanning direction and the sub-scanning direction. The type of actuator of the first conveyor 2D, the second conveyor 2C, and the third conveyor 3C may be modified as appropriate and may be an electromagnetic solenoid or a hydraulic cylinder or the like, in addition to an electric motor. Any plurality of moving parts selected from the first conveyor 2D, the second conveyor 2C, and the third conveyor 3C may be driven by a common actuator as a driving source. The main scanning direction and the sub-scanning direction may be modified as appropriate. The object holder 90 need only be able to hold the cutting object 9 and may be another mat-shaped object, e.g., a tray-shaped object. The sensor 40 need only be able to detect the position of the blade mount 3B in the up-down direction. The arrangement and configuration and the like of the sensor 40 may be modified as appropriate. For example, the sensor 40 may be an encoder that detects the amount of movement of a slit provided in the blade mount 3B, or a sensor that detects the magnitude and direction of a magnetic field generated by a magnet provided on the blade mount 3B. The reference for the position in the up-down direction of the blade mount 3B output by the sensor 40 may be modified as appropriate. The scanner 70 need only be able to detect the presence or absence of the object holder 90 by reading a marker provided on the object holder 90. For example, a reflector-type photointerrupter may be used. The shape, size, and arrangement of the platen 2B and the groove 10 may be modified as appropriate. For example, the sectional shape of the groove 10 may have a U-shape. The groove 10 may also pass completely through the platen 2B in the up-down direction.

The cutting device processing of FIG. 5 and the cutting processing of FIG. 8 may be executed by a processor such as a microcomputer, a special application specific integrated circuit (“ASIC,”), and a field programmable gate array (“FPGA”) instead of the processor 2. The cutting device processing and the cutting processing disclosed in the illustrative embodiments may be executed by a plurality of processors. The memory 74 storing the program for executing the cutting device processing and the cutting processing may be, for example, another non-transitory computer-readable storage medium such as an HDD, SDD, or a hybrid of HDD and SSD. Any non-transitory computer-readable storage medium may be adopted as long as storing information irrespective of a period for storing information. A non-transitory computer-readable storage medium might not necessarily include a transitory computer-readable storage medium (e.g., a signal). The program for executing the cutting device processing and the cutting processing may be downloaded from a server connected to a network (i.e., transmitted to the cutting device 1 as signals) and stored in the memory 74 of the cutting device 1. In such a case, the program may be stored in a non-transitory computer-readable storage medium such as an HDD of the server. In the cutting device processing and the cutting processing according to the illustrative embodiments, the processor 2 might not necessarily execute the steps in the above-described order and may skip one or more of the steps. The cutting device processing and the cutting processing may include one or more other steps. The scope of the disclosure includes a case where, for example, an operating system (“OS”) running on the cutting device 1 executes part or all of actual processing based on an instruction provided by the processor 2 of the cutting device 1 and the functions of the above-described illustrative embodiments are realized. Similarly, with the mobile terminal processing in FIG. 5, a microcomputer, ASIC, or FPGA or the like may be used instead of the CPU 8, as the processor. The mobile terminal processing may be distributed and processed by a plurality of processors. The memory 54 that stores the programs for executing the mobile terminal processing may be configured by another non-transitory storage medium, for example.

The setting method for each of the first to the fifth cutting positions and the cut starting position may be modified as appropriate. The processor 2 may set a predetermined vertical position as the first cutting position P1 regardless of the thickness of the cutting object 9. The processor 2 may give priority to a candidate position close to a corner of the smallest rectangle enclosing the pattern and set this candidate as the cut starting position. The thickness of the cutting object 9 may be a value input by the user. The cut starting position of the first cutting line, the cut starting position of the second cutting line, and the cut starting position of the third cutting line may all be the same position or different positions. Similarly, the cutting direction of the first cutting line, the cutting direction of the second cutting line, and the cutting direction of the third cutting line may all be the same direction or different directions. The second position may be a different position from the first position. The up-down direction may intersect at least one selected from a group of main scanning direction and the sub-scanning direction.

The predetermined condition used to set the second cutting line may be modified as appropriate. The processor 2 may set the sub-cutting lines irrespective of the lengths of the plurality of line segments indicated by the outline data. For example, when the outline data indicates an outline of a circular pattern, the lengths of the plurality of line segments are relatively short. In such a case, the processor 2 may set the second cutting lines by providing a line segment that does not set a sub-cutting line for each of a predetermined number of consecutive line segments, in the plurality of line segments. The processor 2 may set, at the corner, a joint where the cutting object 9 is not cut completely through in the up-down direction, or not set a joint, irrespective of the angle between two consecutive first and second line segments, in the plurality of line segments that form the outline. The offset may be provided at the end point of the first line segment, provided at the starting point of the second line segment, or provided a joint at both the end point of the first line segment and the starting point of the second line segment. The second cutting line may be such that a plurality of sub-cutting lines that form a perforated cut are arranged along the outline. In this case, the cut portion of the perforation passes completely through the cutting object 9 in the up-down direction, the length of the sub-cutting lines may be set to a first predetermined length, and the length between two adjacent sub-cutting lines may be set to a second predetermined length. The first predetermined length and the second predetermined length need only be set in advance. For example, the first predetermined length may be set longer than the second predetermined length. Both the first predetermined length and the second predetermined length need not be constant, but may vary within a predetermined range, taking into account the length of the line segment, the angle formed by adjacent line segments, and the like.

The processor 2 may omit the processing at S23. The processor 2 may determine, based on the placement information, whether the cutting object 9 is placed directly on the platen 2B or whether the cutting object 9 is held by the sheet-shaped object holder 90 placed on the platen 2B. The processor 2 may execute the processing at S71 and S72 in accordance with the cutting information, irrespective of the determination result in the processing at S23. The processor 2 may set the first cutting position P1 and the second cutting position P2 and execute the processing at S46 to S50 even if the processing at S34 is omitted and it is determined that the cutting object 9 is held by the object holder 90 placed on the platen 2B. The cutting device 1 may be configured so as not to be able to communicate with the mobile terminal 4, and need not acquire the outline data and the cutting information specifying the cutting method of the cutting object 9 from the mobile terminal 4 (S21). If the cutting method indicated by the cutting information is not the cutting method according to the determination result of the determination processing, the processor 2 may display an error on the LCD 231, and may omit the processing for notifying the mobile terminal 4 of the error. The method of issuing a notification of an error by the mobile terminal 4 may be modified as appropriate. For example, if the mobile terminal 4 has a speaker, notification of the error may be issued at S8 by the mobile terminal 4. Because the cutting system 5 can transmit instructions from the mobile terminal 4 to the cutting device 1 and receive the execution status of processing by the cutting device 1, the operating portion 23 may be omitted from the cutting device 1.

What is claimed is:

1. A cutting device comprising:
a platen with a groove extending in a main scanning direction,
a blade mount configured to mount a cutting blade,
a first conveyor configured to move the blade mount and a cutting object placed on the platen relatively in the main scanning direction, the cutting object having a sheet shape,
a second conveyor configured to move the blade mount and the cutting object placed on the platen relatively in a sub-scanning direction orthogonal to the main scanning direction,
a third conveyor configured to move the blade mount in an up-down direction orthogonal to both the main scanning direction and the sub-scanning direction,
a processor configured to perform processes comprising:
acquiring outline data indicating an outline of a pattern,
controlling the first conveyor and the second conveyor to move the cutting object and the blade mount relatively to a cut starting position,
controlling the third conveyor to move the blade mount downward to a first cutting position, the first cutting position being a position where a lower end of the cutting blade is below an upper end of the cutting object, and the lower end of the cutting blade is above an upper end of the platen,
controlling the first conveyor and the second conveyor to form a first cutting line by the cutting blade mounted to the blade mount positioned at the first cutting position, the first cutting line being a groove-shaped cut along the outline,
controlling, after forming the first cutting line, the third conveyor to move the blade mount downward to a second cutting position, the second cutting position being a position where the lower end of the cutting blade is below the upper end of the platen, and the lower end of the cutting blade is positioned in the groove, and
controlling the first conveyor and the second conveyor to form a second cutting line by the cutting blade mounted to the blade mount positioned at the second cutting position, the second cutting line being a cut completely passing through the cutting object in the up-down direction along a portion of the outline.

2. The cutting device according to claim 1, wherein
the processor is further configured to perform processes comprising:
acquiring a thickness of the cutting object, and
controlling the third conveyor to move the blade mount downward to the first cutting position set based on the thickness.

3. The cutting device according to claim 2, further comprising:
a detector for outputting a signal indicative of a position in the up-down direction of the blade mount, wherein
the processor is further configured to execute:
acquiring the thickness of the cutting object, based on a detection result from the detector when the cutting blade contacts the cutting object.

4. The cutting device according to claim 1, wherein
the processor is further configured to perform processes comprising:
generating, based on the outline data, first cutting line data and second cutting line data, the first cutting line data being data for forming the first cutting line, and the second cutting line data being data for forming the second cutting line,
controlling, based on the first cutting line data, the first conveyor and the second conveyor to form the first cutting line with the cutting blade mounted to the blade mount positioned at the first cutting position, and
controlling, based on the second cutting line data, the first conveyor and the second conveyor to form the second cutting line with the cutting blade mounted to the blade mount positioned at the second cutting position.

5. The cutting device according to claim 1, wherein
the processor is further configured to perform a process comprising:
controlling the first conveyor and the second conveyor to move the cutting object and the blade mount to the cut starting position set giving priority to, when there are a plurality of the candidate cut starting positions, a candidate position close to a center of a smallest rectangle encompassing the pattern.

6. The cutting device according to claim 4, wherein
the outline data indicates a plurality of line segments forming the outline of the pattern, and
the second cutting line includes a plurality of sub-cutting lines arranged along the outline in accordance with a predetermined condition, the plurality of sub-cutting lines passing completely through the cutting object in the up-down direction, the plurality of sub-cutting lines being separated from each other in a horizontal direction orthogonal to the up-down direction, the predetermined condition including a condition of arranging a first sub-cutting line and a second sub-cutting line when an angle between an arbitrary first line segment and an arbitrary consecutive second line segment, from among the plurality of lines segments, is within a predetermined angle, the first sub-cutting line extending, on the first line segment, from a point at a predetermined position to a first point separated from an intersection point of the first line segment and the second line segment, the second sub-cutting line extending, on the second line segment, from the intersection point to a second point separated from the intersection point and different from the first point.

7. The cutting device according to claim 4, wherein
the outline data indicates a plurality of line segments forming the outline of the pattern, and
the second cutting line includes a plurality of sub-cutting lines arranged along the outline in accordance with a predetermined condition, the plurality of sub-cutting lines passing completely through the cutting object in the up-down direction, the plurality of sub-cutting lines being separated from each other in a horizontal direction orthogonal to the up-down direction, the predetermined condition including a condition of, when a length of any line segment of interest, from among the plurality of line segments, is equal to or longer than a predetermined length, arranging, at predetermined intervals on the line segment of interest, the plurality of sub-cutting lines including a first sub-cutting line and a second sub-cutting line.

8. The cutting device according to claim 1, wherein
the processor is further configured to perform processes comprising:
when it is determined that the cutting object is placed directly on the platen,
controlling the first conveyor and the second conveyor to move the cutting object and the blade mount relatively to the cut starting position,
controlling the third conveyor to move the blade mount downward to the first cutting position,
controlling the first conveyor and the second conveyor to form the first cutting line with the cutting blade mounted to the blade mount positioned at the first cutting position,
controlling, after forming the first cutting line, the third conveyor to move the blade mount downward to the second cutting position, and
controlling the first conveyor and the second conveyor to form the second cutting line with the cutting blade mounted to the blade mount positioned at the second cutting position.

9. The cutting device according to claim 1, wherein
the processor is further configured to perform processes comprising:
when it is determined that the cutting object is held by an object holder placed on the platen,
controlling the first conveyor and the second conveyor to move the cutting object and the blade mount relatively to the cut starting position,
controlling the third conveyor to move the blade mount downward to a third cutting position, the third cutting position being a position where the lower end of the cutting blade is below an upper end of the object holder, and
controlling the first conveyor and the second conveyor to form a third cutting line with the cutting blade mounted to the blade mount positioned at the third cutting position, the third cutting line passing completely through the cutting object in the up-down direction along the outline.

10. The cutting device according to claim 1, wherein
the processor is further configured to perform processes comprising:
when it is determined that the cutting object is held by an object holder placed on the platen,
controlling the first conveyor and the second conveyor to move the cutting object and the blade mount relatively to the cut starting position,
controlling the third conveyor to move the blade mount downward to a fourth cutting position, the fourth cutting position being a position where the lower end of the cutting blade is below the upper end of the cutting object, and the lower end of the cutting blade is above an upper end of the object holder,
controlling the first conveyor and the second conveyor to form the first cutting line with the cutting blade mounted to the blade mount positioned at the fourth cutting position,
controlling, after forming the first cutting line, the third conveyor to move the blade mount downward to a fifth cutting position, the fifth cutting position being a position where the lower end of the cutting blade is below the upper end of the object holder, and
controlling the first conveyor and the second conveyor to form the second cutting line with the cutting blade mounted to the blade mount positioned at the fifth cutting position.

11. A cutting system provided with a cutting device, and a mobile terminal configured to communicate with the cutting device,
the mobile terminal comprising:
a mobile memory storing computer-readable instructions,
a terminal processor configured to perform processes comprising:
receiving an input of cutting information specifying a cutting method of a cutting object, the cutting object having a sheet shape, and
transmitting the cutting information to the cutting device,
the cutting device comprising:
a platen with a groove extending in a main scanning direction,
a blade mount configured to mount a cutting blade,
a first conveyor configured to move the blade mount and a cutting object placed on the platen relatively in the main scanning direction, the cutting object having a sheet shape,
a second conveyor configured to move the blade mount and the cutting object placed on the platen relatively in a sub-scanning direction orthogonal to the main scanning direction,
a third conveyor configured to move the blade mount in an up-down direction orthogonal to both the main scanning direction and the sub-scanning direction,
a cutting memory storing computer-readable instructions, and
a cutting processor configured to perform processes comprising:
receiving the cutting information transmitted from the mobile terminal,
acquiring outline data indicating an outline of a pattern,
controlling the first conveyor and the second conveyor to move the cutting object and the blade mount relatively to a cut starting position,
controlling the third conveyor to move the blade mount downward to a first cutting position, the first cutting position being a position where, when the cutting information indicates the cutting method for cutting the cutting object when the cutting object is placed directly on the platen, a lower end of the cutting blade is below an upper end of the cutting object, and the lower end of the cutting blade is above an upper end of the platen,
controlling the first conveyor and the second conveyor to form a first cutting line by the cutting blade mounted to the blade mount positioned at the first cutting position, the first cutting line being a groove-shaped cut along the outline,
controlling, after forming the first cutting line, the third conveyor to move the blade mount downward to a second cutting position, the second cutting position being a position where the lower end of the cutting blade is below the upper end of the platen, and the lower end of the cutting blade is positioned in the groove, and
controlling the first conveyor and the second conveyor to form a second cutting line by the cutting blade mounted to the blade mount positioned at the second cutting position, the second cutting line being a cut completely passing through the cutting object in the up-down direction along a portion of the outline.

12. The cutting system according to claim 11, wherein:
the terminal processor is further configured to perform a process comprising:
issuing a notification of an error if the cutting method indicated by the cutting information is not the cutting method corresponding to a determination result of whether the cutting object is directly placed on the platen or held by an object holder placed on the platen.

13. A cutting device comprising:
a platen having an upper surface and a groove, the groove being a depression recessed downward from the upper surface, the groove extending in a main scanning direction,
a blade mount configured to mount a cutting blade, the cutting blade being disposed to face the groove,
a first conveyor configured to move the blade mount relative to the platen in the main scanning direction to move a lower end of the cutting blade along the groove,
a second conveyor configured to move a sheet placed on the platen relative to the platen in a sub-scanning direction intersecting the main scanning direction,
a third conveyor configured to move the blade mount relative to the sheet placed on the platen in an up-down direction intersecting both the main scanning direction and the sub-scanning direction,
a processor configured to perform processes comprising:
acquiring outline data indicating an outline of a pattern,
controlling the first conveyor and the second conveyor to move the blade mount to a cut starting position,
controlling the third conveyor to move the blade mount downward from a first initial position to a first cutting position, the first initial position being a position where the lower end of the cutting blade is positioned above an upper surface of the sheet, the first cutting position being a position where the lower end of the cutting blade is positioned between the upper surface of the sheet and the upper surface of the platen,
controlling the first conveyor and the second conveyor to form a first cutting line by the cutting blade mounted to the blade mount positioned at the first cutting position, the first cutting line being a groove-shaped cut along the outline,
controlling, after forming the first cutting line, the third conveyor to move the blade mount downward from a second initial position to a second cutting position, the second initial position being a position where the lower end of the cutting blade is positioned above the upper surface of the sheet, the second cutting position being a position where the lower end of the cutting blade is positioned below the upper surface of the platen, and
controlling the first conveyor and the second conveyor to form a second cutting line by the cutting blade mounted to the blade mount positioned at the second cutting position, the second cutting line being a cut completely passing through the sheet in the up-down direction along a portion of the outline.
